(19) United States
(12) Patent Application Publication
(10) Pub. No.: US 2026/0147503 A1
(43) Pub. Date: May 28, 2026

(54) STORAGE DEVICE FOR MANAGING COMPRESSED MAPPING INFORMATION AND METHOD OF OPERATING THE SAME

(71) Applicant: SK hynix Inc., Gyeonggi-do (KR)

(72) Inventor: Nam Hyun YUN, Gyeonggi-do (KR)

(21) Appl. No.: 19/177,659

(22) Filed: Apr. 14, 2025

(30) Foreign Application Priority Data
Nov. 25, 2024 (KR) 10-2024-0169888

(51) Int. Cl. G06F 3/06

(52) U.S. Cl. CPC G06F 3/0655; G06F 3/0604; G06F 3/0679

(57) ABSTRACT

A storage device comprising a memory device including a plurality of storage spaces respectively corresponding to a plurality of physical addresses, and a controller configured to receive at least one of K logical addresses for a write operation, store the at least one of K logical addresses in an buffer, search for and select, from among the at least one of K logical addresses stored in the buffer, a target logical address of a location including an N-bit value, obtained by applying a preset conversion rule to an N-bit value included in the location corresponding to a target physical address, and generate, when the target logical address is searched for, compressed mapping information by mapping, to the target logical address, a target compressed physical address generated by removing, from the target physical address, the N-bit value in the location corresponding to the target physical address.

### CROSS-REFERENCE TO RELATED APPLICATION

This application claims priority under 35 U.S.C. § 119(a) to Korean Patent Application No. 10-2024-0169888 filed on Nov. 25, 2024, the entire contents of which are incorporated herein by reference.

### BACKGROUND

### 1. Field

Various embodiments of the present disclosure generally relate to a storage device, and more particularly, to a storage device that compresses and manages mapping information between logical addresses and physical addresses, and a method of operating the storage device.

### 2. Discussion of the Related Art

Memory systems may refer to storage devices embodied using a semiconductor such as silicon (Si), germanium (Ge), gallium arsenide (GaAs), indium phosphide (InP), or the like. The memory systems are generally classified into volatile memory devices and nonvolatile memory devices. A volatile memory device is configured to lose data stored therein when power supply is interrupted. Representative examples of the volatile memory device include a static RAM (SRAM), a dynamic RAM (DRAM), a synchronous DRAM (SDRAM), etc. A nonvolatile memory device is configured to retain data stored therein even when the power supply is interrupted. Representative examples of the nonvolatile memory device include a read only memory (ROM), a programmable ROM (PROM), an electrically programmable ROM (EPROM), an electrically erasable programmable ROM (EEPROM), a flash memory, a phase-change random access memory (PRAM), a magnetic RAM (MRAM), a resistive RAM (RRAM), a ferroelectric RAM (FRAM), etc. Flash memories may include a NOR-type flash memory and a NAND-type flash memory.

A storage device may further include a controller (i.e., a memory controller) for controlling a memory (for example, a volatile memory/a nonvolatile memory), and such a controller may receive a command from an external device (i.e., a host), and perform data read, write, and erase operations on a memory included in the storage device based on the received command or control the operations.

On the other hand, the size of memory capacity required in a computing system continues to increase. In particular, in the case of a volatile memory which is more expensive per capacity than a nonvolatile memory, increasing the size of memory capacity is more difficult.

Therefore, a method for compressing and storing data stored in the volatile memory included in the storage device has been proposed.

### SUMMARY

Various embodiments of the present disclosure are directed to providing a storage device capable of compressing and managing mapping information between logical addresses and physical addresses, and a method of operating the storage device.

The problems to be solved by the present disclosure are not limited to the above-mentioned problems, and the other unmentioned problems will be clearly understood from the following description by those skilled in the art.

In accordance with an embodiment of the present disclosure, a method of operating a storage device including a memory device with a plurality of storage spaces respectively corresponding to a plurality of physical addresses, the method may include: a receiving operation of receiving at least one of K logical addresses for a write operation, where K is a natural number; a determination operation of determining an N-bit value included in a location corresponding to a target physical address among the plurality of physical addresses, where N is a natural number; a logical selection operation of searching for and selecting, from among the at least one of K logical addresses received in the receiving operation, a target logical address of a location including an N-bit value, obtained by applying a preset conversion rule to the N-bit value determined in the determination operation; and a first generation operation of generating, in response to the target logical address searched for in the logical selection operation, compressed mapping information by mapping, to the target logical address, a target compressed physical address generated by removing, from the target physical address, the N-bit value in the location corresponding to the target physical address.

In accordance with an embodiment of the present disclosure, a storage device may include: a memory device including a plurality of storage spaces respectively corresponding to a plurality of physical addresses; and a controller configured to receive at least one of K logical addresses for a write operation, store the at least one of K logical addresses in an internal address buffer, search for and select, from among the at least one of K logical addresses stored in the address buffer, a target logical address of a location including an N-bit value, obtained by applying a preset conversion rule to an N-bit value included in the location corresponding to a target physical address of the plurality of physical addresses, and generate, when the target logical address is searched for, compressed mapping information by mapping, to the target logical address, a target compressed physical address generated by removing, from the target physical address, the N-bit value in the location corresponding to the target physical address, wherein each of K and N is a natural number.

### BRIEF DESCRIPTION OF THE DRAWINGS

FIGS. 1A to 1C are diagrams illustrating a data processing system including a storage device according to an embodiment of the present disclosure.

FIG. 2 is a diagram illustrating an operation of managing mapping information in a storage device according to an embodiment of the present disclosure.

FIGS. 3A to 3G are diagrams illustrating an operation of compressing and managing mapping information in a storage device according to an embodiment of the present disclosure.

FIGS. 4A to 4G are diagrams illustrating an operation of compressing and storing mapping information in a storage device according to an embodiment of the present disclosure.

FIG. 5 is a flowchart illustrating a sequence of an operation of compressing and storing mapping information in a storage device according to an embodiment of the present disclosure.

### DETAILED DESCRIPTION

Various embodiments of the present disclosure are described below with reference to the accompanying drawings. Elements and features of this disclosure, however, may be configured or arranged differently to form other embodiments, which may be variations of any of the disclosed embodiments.

In this disclosure, references to various features (e.g., elements, structures, modules, components, steps, operations, characteristics, etc.) included in “one embodiment,” “example embodiment,” “an embodiment,” “another embodiment,” “some embodiments,” “various embodiments,” “other embodiments,” “alternative embodiment,” and the like are intended to mean that any such features are included in one or more embodiments of the present disclosure, but may or may not necessarily be combined in the same embodiments.

In this disclosure, the terms “comprise,” “comprising,” “include,” and “including” are open-ended. As used in the appended claims, these terms specify the presence of the stated elements and do not preclude the presence or addition of one or more other elements. The terms in a claim do not foreclose the apparatus from including additional components (e.g., an interface unit, circuitry, etc.).

In this disclosure, various units, circuits, or other components may be described or claimed as “configured to” perform a task or tasks. In such contexts, “configured to” is used to connote structure by indicating that the blocks/units/circuits/components include structure (e.g., circuitry) that performs one or more tasks during operation. As such, the block/unit/circuit/component can be said to be configured to perform the task even when the specified block/unit/circuit/component is not currently operational (e.g., is not turned on nor activated). The block/unit/circuit/component used with the “configured to” language includes hardware-for example, circuits, memory storing program instructions executable to implement the operation, etc. Additionally, “configured to” can include a generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that implement or perform one or more tasks.

As used in this disclosure, the term ‘circuitry’ or ‘logic’ refers to all of the following: (a) hardware-only circuit implementations (such as implementations in only analog and/or digital circuitry) and (b) combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions and (c) circuits, such as a microprocessor(s) or a portion of a microprocessor(s), that require software or firmware for operation, even if the software or firmware is not physically present. This definition of ‘circuitry’ or ‘logic’ applies to all uses of this term in this application, including in any claims. As a further example, as used in this application, the term “circuitry” or “logic” also covers an implementation of merely a processor (or multiple processors) or a portion of a processor and its (or their) accompanying software and/or firmware. The term “circuitry” or “logic” also covers, for example, and if applicable to a particular claim element, an integrated circuit for a storage device.

As used herein, the terms “first,” “second,” “third,” and so on are used as labels for nouns that the terms precede, and do not imply any type of ordering (e.g., spatial, temporal, logical, etc.). The terms “first” and “second” do not necessarily imply that the first value must be written before the second value. Further, although the terms may be used herein to identify various elements, these elements are not limited by these terms. These terms are used to distinguish one element from another element that otherwise have the same or similar names. For example, a first circuitry may be distinguished from a second circuitry.

Further, the term “based on” is used to describe one or more factors that affect a determination. This term does not foreclose additional factors that may affect a determination. That is, a determination may be solely based on those factors or based, at least in part, on those factors. For example, the phrase “determine A based on B.” While in this case, B is a factor that affects the determination of A, such a phrase does not foreclose the determination of A from also being based on C. In other instances, A may be determined based solely on B.

Herein, an item of data, a data item, a data entry or an entry of data may be a sequence of bits. For example, the data item may include the contents of a file, a portion of the file, a page in memory, an object in an object-oriented program, a digital message, a digital scanned image, a part of a video or audio signal, metadata or any other entity which can be represented by a sequence of bits. According to an embodiment, the data item may include a discrete object. According to another embodiment, the data item may include a unit of information within a transmission packet between two different components.

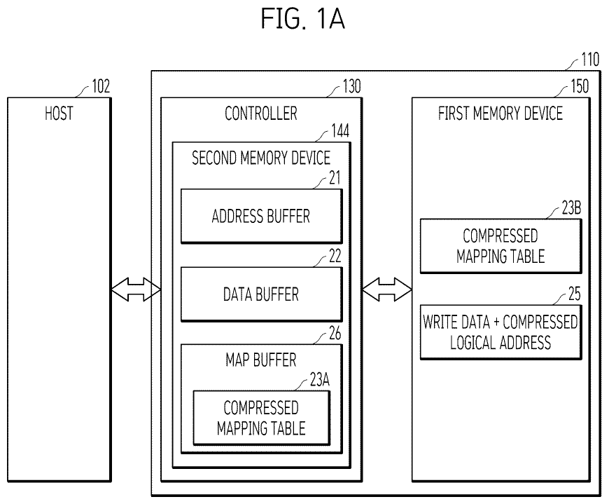

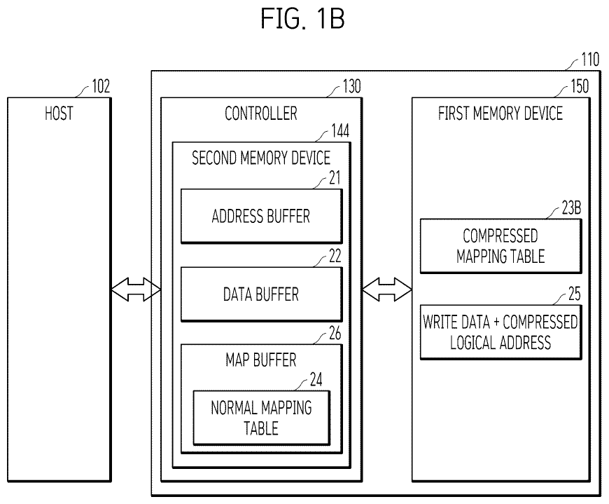

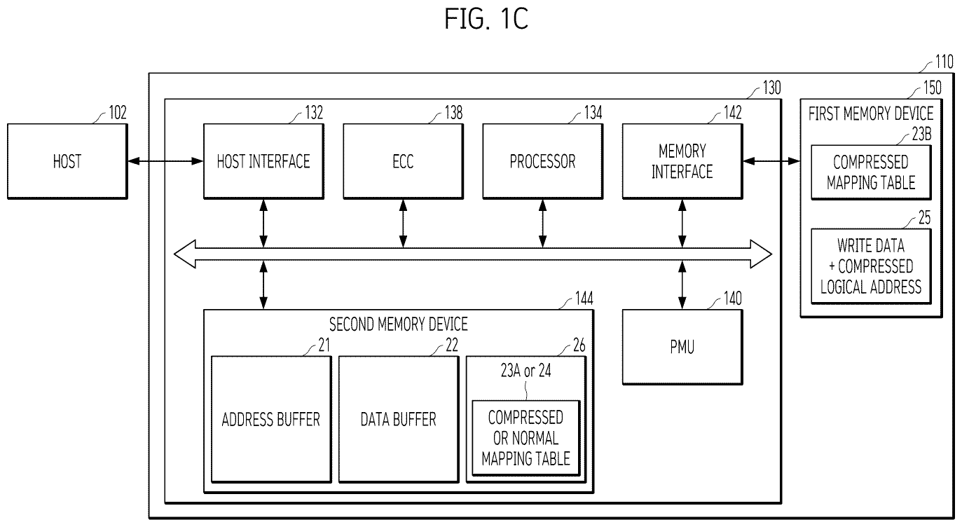

FIGS. 1A to 1C are diagrams illustrating a data processing system including a storage device according to an embodiment of the present disclosure.

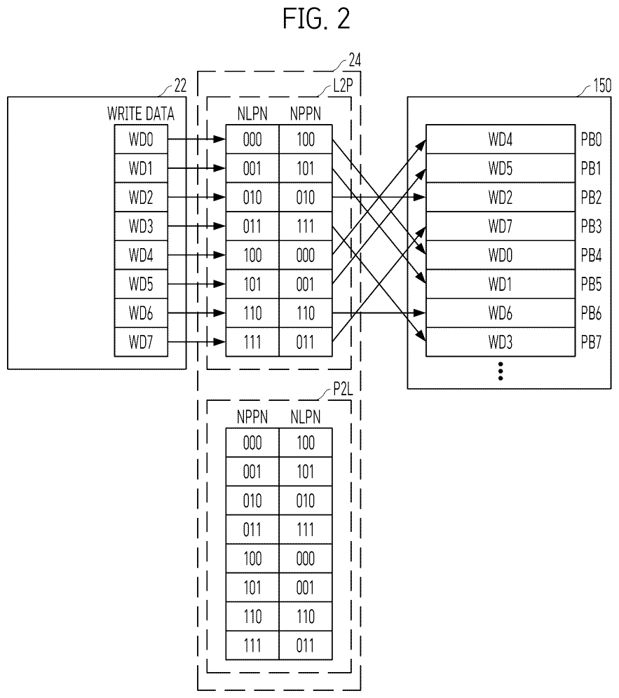

FIG. 2 is a diagram illustrating an operation of managing mapping information in a storage device according to an embodiment of the present disclosure.

Referring to FIGS. 1A to 1C, the data processing system may include a host 102 engaged or coupled with a memory system (i.e., the storage device 110). For example, the host 102 and the storage device 110 can be coupled to each other via a data bus, a host cable and the like to perform data communication.

The storage device 110 may include a first memory device 150 and a controller 130. The first memory device 150 and the controller 130 in the storage device 110 may be considered components or elements physically separated from each other. The first memory device 150 and the controller 130 may be connected via at least one data path. For example, the data path may include a channel and/or a way.

According to an embodiment, the first memory device 150 and the controller 130 may be components or elements functionally divided. Further, according to an embodiment, the first memory device 150 and the controller 130 may be implemented with a single chip or a plurality of chips. The controller 130 may perform a data input/output operation in response to a request input from the external device. For example, when the controller 130 performs a read operation in response to a read request input from an external device, data stored in a plurality of non-volatile memory cells included in the first memory device 150 is transferred to the controller 130.

Furthermore, the controller 130 may include a second memory device 144 therein.

That is, the controller 130 may control the first memory device 150 external to the controller 130 or the second memory device 144 within the controller 130 in order to perform an operation, such as read, program/write, or erase, which corresponds to a request from the host 102. Furthermore, the controller 130 may control the first memory device 150 or the second memory device 144 in order to independently operate the storage device 110 regardless of a request from the host 102.

According to an embodiment, the first and second memory devices 150 and 144 may each be volatile memory or nonvolatile memory.

Furthermore, the first memory device 150 may include a plurality of storage spaces each of which corresponds to a different one of a plurality of physical addresses. The first memory device 150 may manage data in units of at least one storage space. For example, in case that the first memory device 150 is a non-volatile memory device, any of a single page, a single block, or a single super block may be applied as each storage space. As another example, in case that the first memory device 150 is a volatile memory device, each storage space is a preset data processing unit, which is determined by the number of data pads multiplied by the burst length.

Furthermore, the controller 130 and the first memory device 150 may be components that are physically divided. The first memory device 150 and the controller 130 may be connected by at least one data path. For example, the data path may consist of a channel and/or a way.

Furthermore, the second memory device 144 included in the controller 130 may be connected to other components 132, 134, 138, 140, and 142 within the controller 130 through a data bus.

Specifically, the storage device 110 according to an embodiment of the present disclosure may generate compression data by compressing write data, and may manage the generated compression data in the first memory device 150. According to an embodiment, managing, by the storage device 110, compression data in the first memory device 150 may mean that an access operation for the compression data is performed only in the first memory device 150 in the state in which the compression data have been stored in the first memory device 150.

Furthermore, the storage device 110 may use the second memory device 144 as an operational memory for the storage device 110 and the controller 130, to store data necessary for control when the controller 130 responds to a request from the host 102 or controls the first memory device 150 to perform an internal operation.

The second memory device 144 may temporarily store data read from the first memory device 150 before providing the data to the host 102 during a process in which the controller 130 controls the first memory device 150 in response to a request from the host 102. The controller 130 may temporarily store write data provided from the host 102 in the second memory device 144 before the write data is stored in the first memory device 150. In addition, when the controller 130 controls operations of the first memory device 150, such as a read operation, a write (or program) operation, and an erase operation, data transmitted between or generated by the controller 130 and the first memory device 150 in the storage device 110 may be stored in the second memory device 144.

For example, the second memory device 144 stores metadata needed to perform operations, such as a data write operation and a read operation, between the host 102 and the first memory device 150, as well as data during the execution of the operations such as the data write operation and the read operation. To store the aforementioned data, the second memory device 144 may include an address buffer 21, a data buffer 22, a map buffer 26, and the like. For example, the controller 130 may store at least some of a plurality of normal logical addresses received for a write operation and a read operation in the address buffer 21. The controller 130 may store at least some of a plurality of pieces of write data and read data transmitted during a write operation and a read operation in the data buffer 22. The controller 130 may store, in the map buffer 26, at least some of a plurality of pieces of mapping information that define a correspondence between a plurality of normal logical addresses used by the host 102 and a plurality of normal physical addresses indicating a plurality of storage spaces included in the first memory device 150.

For reference, the second memory device 144 may be present inside the controller 130, as illustrated in the drawings. Alternatively, the second memory device 144 may be provided outside the controller 130, unlike what is shown in the drawings. In this case, the second memory device 144 should be implemented with an external memory device through which data is input to and output from the controller 130 via a separate memory interface.

In an embodiment, write data is data that is requested to be written from the host 102 to the storage device 110.

In an embodiment, write data is data that is generated in the controller 130 to perform an operation of the storage device 110.

More specifically, with reference to FIGS. 1A to 1C and FIG. 2, a scheme can be understood to generate and manage a plurality of pieces of normal mapping information NLPN:NPPN and NPPN:NLPN that defines a correspondence between a plurality of normal logical addresses NLPN used by the host 102 and normal physical addresses NPPN indicating storage spaces included in the first memory device 150.

The controller 130 may receive a write command (not illustrated), write data WRITE DATA, and a normal logical address NLPN, from the host 102 to perform a write operation. The controller 130 may write and store the write data WRITE DATA in a plurality of storage spaces PB<0:7, . . . > included in the first memory device 150, in response to the write command.

The controller 130 may generate and update a normal mapping table 24 for the write data WRITE DATA, and then write and store the write data WRITE DATA in the plurality of storage spaces PB<0:7, . . . > of the first memory device 150. For example, the normal mapping table 24 includes logical-to-physical information L2P and physical-to-logical information P2L for the write data WRITE DATA stored in the plurality of storage spaces PB<0:7, . . . >.

The logical-to-physical information L2P and physical-to-logical information P2L may be information that defines a correspondence between the plurality of normal logical addresses NLPN that are used by the host 102 and the plurality of normal physical addresses NPPN that indicate the plurality of storage spaces PB<0:7, . . . > included in the first memory device 150.

For example, the controller 130 stores data segments WD<0:7> of the write data WRITE DATA corresponding to a write command received from the host 102 in the data buffer 22 included in the second memory device 144 of the controller 130. Subsequently, the controller 130 stores the write data WRITE DATA stored in the data buffer 22, in the plurality of storage spaces PB<0:7, . . . > of the first memory device 150.

Furthermore, the controller 130 may generate L2P segments NLPN:NPPN and P2L segments NPPN:NLPN as the data segments WD<0:7> of the write data WRITE DATA are stored in the plurality of storage spaces PB<0:7, . . . > of the first memory device 150, and then store the L2P segments NLPN:NPPN and the P2L segments NPPN:NLPN in the map buffer 26 included in the second memory device 144 of the controller 130. In the second memory device 144 of the controller 130, the map buffer 26 may store the L2P segments NLPN:NPPN and the P2L segments NPPN:NLPN as a normal mapping table 24 in a table format. Subsequently, the controller 130 may store the L2P segments NLPN:NPPN and the P2L segments NPPN:NLPN stored in the map buffer 26 in the plurality of storage spaces PB<0:7, . . . > of the first memory device 150 through a map flush operation.

The controller 130 may receive a read command (not illustrated) and a normal logical address NLPN from the host 102. For example, the controller 130 may read a normal mapping table 24 that includes L2P segments NLPN:NPPN and P2L segments NPPN:NLPN that correspond to the normal logical address NLPN associated with the read command, from the first memory device 150, and load the normal mapping table 24 into the map buffer 26. Subsequently, the controller 130 may determine a normal physical address NPPN corresponding to the normal logical address NLPN associated with the read command, with reference to the L2P segments NLPN:NPPN and the P2L segments NPPN:NLPN of the normal mapping table 24 loaded into the map buffer 26. Upon determining the corresponding normal physical address NPPN, the controller 130 may read data stored in a specific storage space among the plurality of storage spaces PB<0:7, . . . > included in the first memory device 150, store the read data in the data buffer 22, and provide the read data to the host 102.

The L2P segments NLPN:NPPN included in the normal mapping table 24 may be optimized for searching for a normal physical address corresponding to a specific normal logical address, thereby enhancing efficiency in searching for the normal physical address mapped to the normal logical address input from the host 102 during a read operation.

The P2L segments NPPN:NLPN included in the normal mapping table 24 may be optimized for a write operation. The controller 130, when receiving a write command, write data WRITE DATA, and a normal logical address NLPN from the host 102, needs to rapidly allocate a storage space in the first memory device 150 to store the write data WRITE DATA. The controller 130 may pre-load, into the map buffer 26, a list of normal physical addresses NPPN corresponding to storage spaces in the first memory device 150 that can be further allocated. Therefore, at a time point when the write command, the write data WRITE DATA, and the normal logical address NLPN are received from the host 102, the controller 130 may rapidly search the list of normal physical addresses NPPN loaded in the map buffer 26, map a normal physical address NPPN corresponding to a storage space available for storing the write data WRITE DATA with the normal logical address NLPN, and then store the write data WRITE DATA in a specific storage space corresponding to the normal physical address NPPN. In this process, a P2L segment NPPN:NLPN may be generated and temporarily stored in the map buffer 26. The P2L segment NPPN:NLPN stored in the map buffer 26 may be stored in the first memory device 150 through a map flush operation.

The controller 130 according to an embodiment of the present disclosure may generate and manage a compressed mapping table 23A or 23B formed by appropriately compressing the normal mapping table 24 described in FIG. 2, rather than using the normal mapping table 24 as it is. The compressed mapping table 23A or 23B may occupy a smaller storage space than the normal mapping table 24.

In an embodiment, as illustrated in FIG. 1A, the controller 130 manages the compressed mapping table 23A or 23B in the internal second memory device 144, and backs up the compressed mapping table 23A or 23B to the first memory device 150. The controller 130 may back up the entire compressed mapping table 23A or 23B to the first memory device 150 and, with at least a portion of the compressed mapping table 23A or 23B stored in the second memory device 144, perform an access operation on the compressed mapping table 23A or 23B in the second memory device 144.

In an embodiment, the controller 130 manages the compressed mapping table 23A or 23B as a normal mapping table 24 by decompressing the compressed mapping table 23A or 23B, in the second memory device 144, as illustrated in FIG. 1B, and backs up the compressed mapping table 23A or 23B to the first memory device 150. The controller 130 may back up the entire compressed mapping table 23A or 23B to the first memory device 150, decompress at least a portion of the compressed mapping table 23A or 23B to convert the decompressed portion into a normal mapping table 24 and, with the converted normal mapping table 24 stored in the second memory device 144, perform an access operation on the normal mapping table 24 in the second memory device 144.

In an embodiment, unlike in FIGS. 1A and 1B, the controller 130 may store neither the compressed mapping table 23A or 23B nor the normal mapping table 24 in the internal second memory device 144, but may store the compressed mapping table 23A or 23B in only the first memory device 150. The controller 130 may divide a plurality of storage spaces PB<0:7, . . . > included in the first memory device 150 into a first storage area and a second storage area, store data in the first storage area, and store the compressed mapping table 23A or 23B in the second storage area. In this case, the controller 130 may perform an access operation on the first storage area by referring to the compressed mapping table 23A or 23B stored in the second storage area of the first memory device 150.

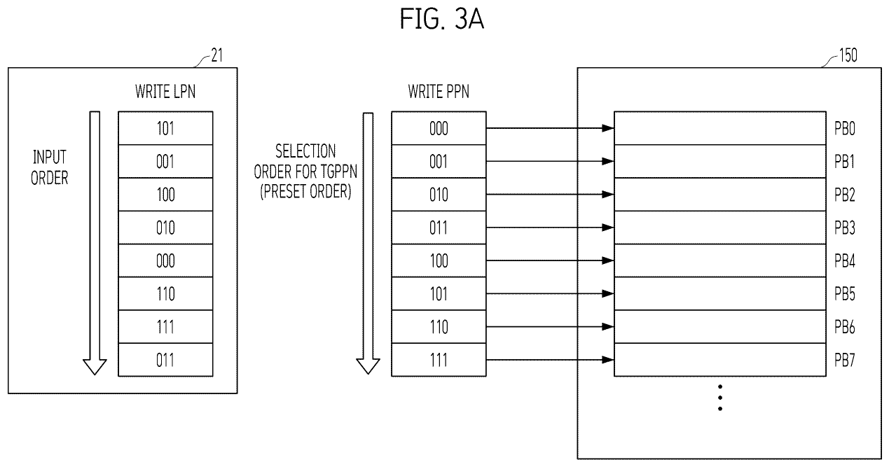

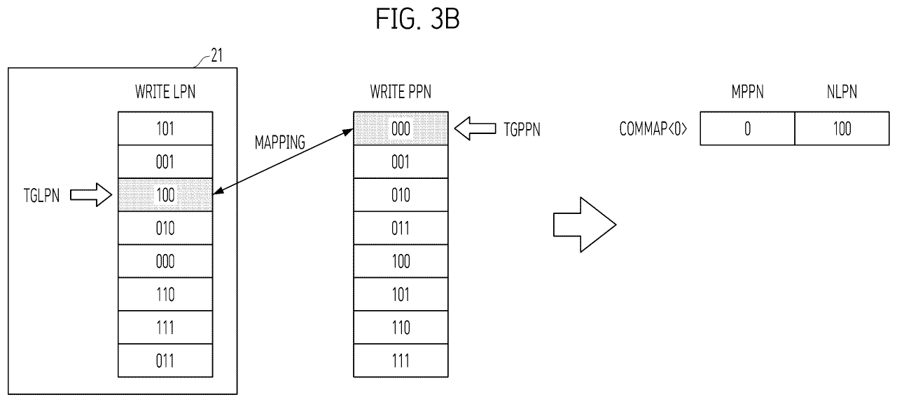

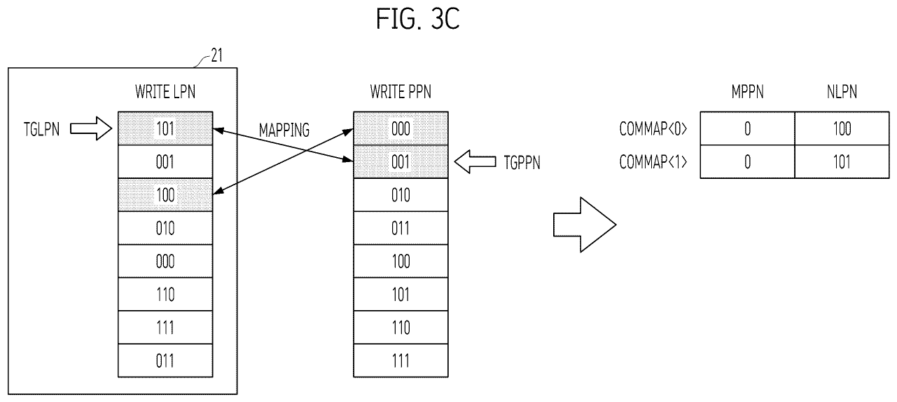

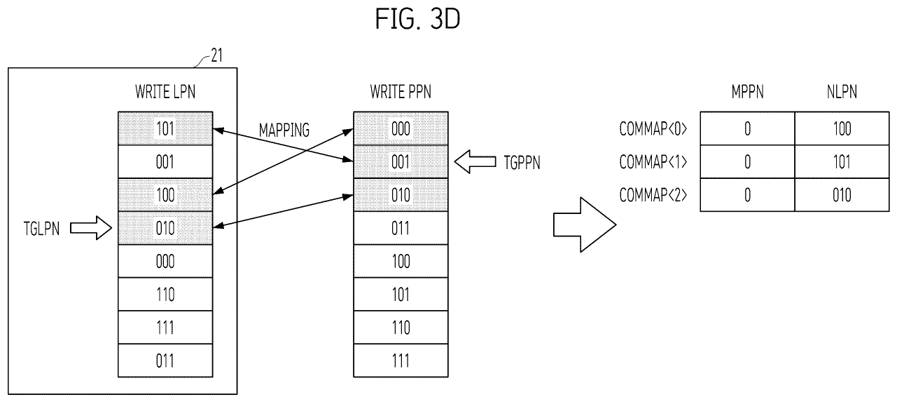

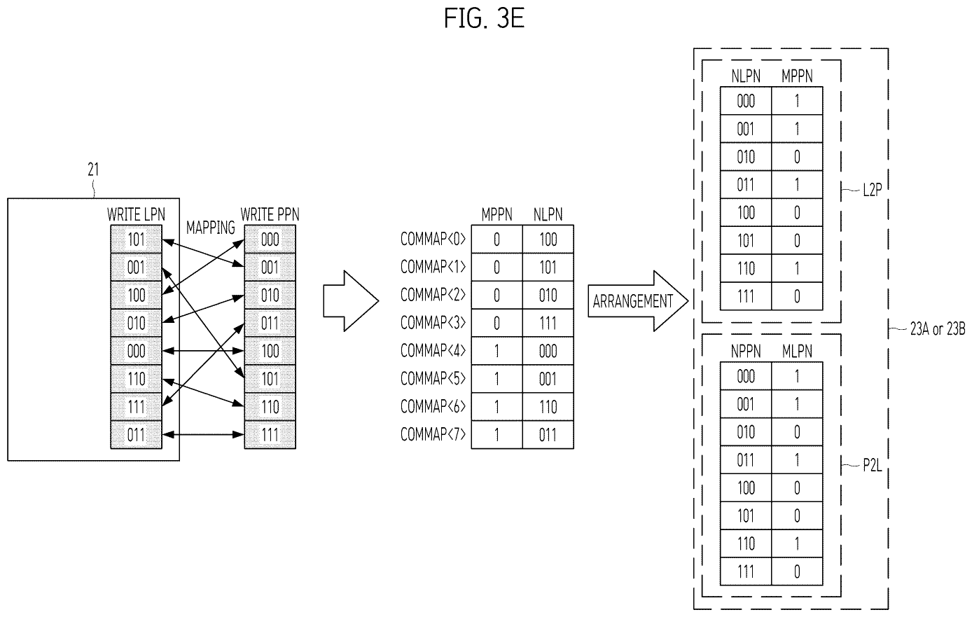

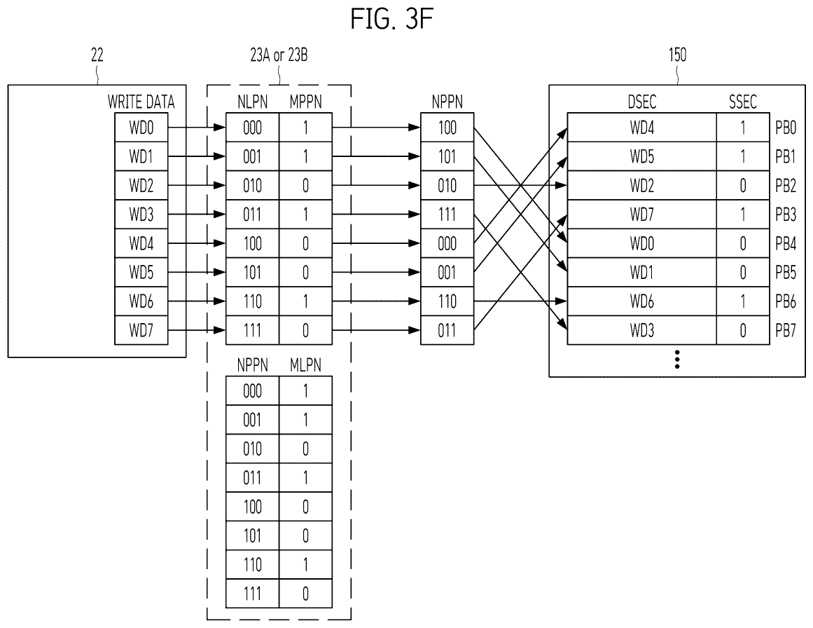

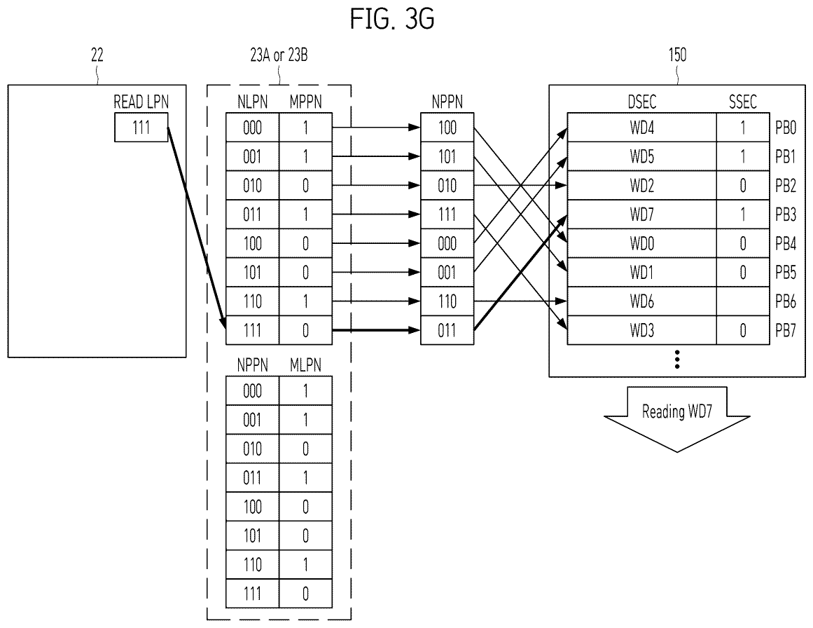

For reference, differences between the normal mapping table 24 and the compressed mapping table 23A or 23B, and a specific generating method thereof will be described with reference to FIGS. 3A to 5.

Referring to FIG. 1C, the controller 130 according to an embodiment of the present disclosure may include a host interface 132, a processor 134, a power management unit (PMU) 140, a memory interface 142, and an error correction unit (error correction code (ECC)) 138 along with the second memory device 144.

The host 102 and the memory system 110 each may include a controller or an interface for transmitting and receiving signals, data, and the like, in accordance with one or more predetermined protocols. For example, the host interface 132 in the memory system 110 may include an apparatus capable of transmitting signals, data, and the like to the host 102 or receiving signals, data, and the like from the host 102.

The host interface 132 included in the controller 130 may receive signals, commands (or requests), and/or data input from the host 102 via a bus. For example, the host 102 and the memory system 110 may use a predetermined set of rules or procedures for data communication or a preset interface to transmit and receive data therebetween.

Examples of communication standards or interfaces used to transmit/receive data may include various form factors such as 2.5-inch form factor, 1.8-inch form factor, MO-297, MO-300, M.2, and EDSFF (Enterprise and Data Center SSD Form Factor) and various communication standards or interfaces such as USB (Universal Serial Bus), MMC (Multi-Media Card), PATA (Parallel Advanced Technology Attachment), SCSI (Small Computer System Interface), ESDI (Enhanced Small Disk Interface), IDE (Integrated Drive Electronics), PCIe (Peripheral Component Interconnect Express), SAS (Serial-attached SCSI), SATA (Serial Advanced Technology Attachment), and MIPI (Mobile Industry Processor Interface).

According to an embodiment, the host interface 132 is a type of layer for exchanging data with the host 102 and is implemented with, or driven by, firmware called a host interface layer (HIL). According to an embodiment, the host interface 132 can include a command queue.

The Integrated Drive Electronics (IDE) or Advanced Technology Attachment (ATA) may be used as one of the interfaces for transmitting and receiving data and, for example, may use a cable including 40 wires connected in parallel to support data transmission and data reception between the host 102 and the memory system 110. When a plurality of memory systems 110 are connected to a single host 102, the plurality of memory systems 110 may be divided into a master and a slave by using a position or a dip switch to which the plurality of memory systems 110 are connected. The memory system 110 set as the master may be used as a main memory device. The IDE (ATA) may include, for example, Fast-ATA, ATAPI, or Enhanced IDE (EIDE).

A Serial Advanced Technology Attachment (SATA) interface is a type of serial data communication interface that is compatible with various ATA standards of parallel data communication interfaces which are used by Integrated Drive Electronics (IDE) devices. The 40 wires in the IDE interface can be reduced to six wires in the SATA interface. For example, 40 parallel signals for the IDE can be converted into 6 serial signals for the SATA interface. The SATA interface has been widely used because of its faster data transmission and reception rate and its less resource consumption in the host 102 used for the data transmission and reception. The SATA interface may connect up to 30 external devices to a single transceiver included in the host 102. In addition, the SATA interface can support hot plugging that allows an external device to be attached to or detached from the host 102, even while data communication between the host 102 and another device is being executed. Thus, the memory system 110 can be connected or disconnected as an additional device, like a device supported by a universal serial bus (USB) even when the host 102 is powered on. For example, in the host 102 having an eSATA port, the memory system 110 may be freely attached to or detached from the host 102 like an external hard disk.

Small Computer System Interface (SCSI) is a type of serial data communication interface used for connecting a computer or a server with other peripheral devices. The SCSI can provide a high transmission speed, as compared with other interfaces such as IDE and SATA. In the SCSI, the host 102 and at least one peripheral device (e.g., memory system 110) are connected in series, but data transmission and reception between the host 102 and each peripheral device may be performed through a parallel data communication. In the SCSI, it is easy to connect or disconnect a device such as the memory system 110 to or from the host 102. The SCSI can support connections of 15 other devices to a single transceiver included in host 102.

Serial Attached SCSI (SAS) can be understood as a serial data communication version of the SCSI. In the SAS, the host 102 and a plurality of peripheral devices are connected in series, and data transmission and reception between the host 102 and each peripheral device may be performed in a serial data communication scheme. The SAS can support connection between the host 102 and the peripheral device through a serial cable instead of a parallel cable, to easily manage equipment using the SAS and enhance or improve operational reliability and communication performance. The SAS may support connections of eight external devices to a single transceiver included in the host 102.

The Non-volatile memory express (NVMe) is a type of interface based at least on a Peripheral Component Interconnect Express (PCIe) designed to increase performance and design flexibility of the host 102, servers, computing devices, and the like equipped with the non-volatile memory system 110. The PCIe can use a slot or a specific cable for connecting a computing device (e.g., host 102) and a peripheral device (e.g., memory system 110). For example, the PCIe can use a plurality of pins (e.g., 18 pins, 32 pins, 49 pins, or 82 pins) and at least one wire (e.g., x1, x4, x8, or x16) to achieve high speed data communication over several hundred MB per second (e.g., 250 MB/s, 500 MB/s, 984.6250 MB/s, or 1969 MB/s). According to an embodiment, the PCIe scheme may achieve bandwidths of tens to hundreds of Giga bits per second. The NVMe can support an operation speed of the non-volatile memory system 110, such as an SSD, that is faster than a hard disk.

According to an embodiment, the host 102 and the memory system 110 may be connected through a universal serial bus (USB). The Universal Serial Bus (USB) is a type of scalable, hot-pluggable plug-and-play serial interface that can provide cost-effective standard connectivity between the host 102 and peripheral devices such as a keyboard, a mouse, a joystick, a printer, a scanner, a storage device, a modem, a video camera, and the like. A plurality of peripheral devices such as the memory system 110 may be coupled to a single transceiver included in the host 102.

The error correction unit 138 may check and correct errors in data transmitted between the controller 130 and the first memory device 150. The error correction unit 138 may be implemented as a separate module, circuit or firmware in the controller 130, but also be implemented in the first memory device 150 according to an embodiment.

The error correction circuitry 138 may include all circuits, modules, systems, and/or devices for performing the error correction operation based on at least one of the above-described codes.

The error correction circuitry 138 can correct error bits of data read from the first memory device 150, and may include an error correction code (ECC) encoder and an ECC decoder. The ECC encoder may perform error correction encoding of data to be programmed in the first memory device 150 to generate encoded data into which a parity bit is added, and store the encoded data in the first memory device 150. The ECC decoder can detect and correct error bits contained in the data read from the first memory device 150 when the controller 130 reads the data stored in the first memory device 150. For example, after performing error correction decoding on the data read from the first memory device 150, the error correction circuitry 138 determines whether the error correction decoding has succeeded or not, and outputs an instruction signal, e.g., a correction success signal or a correction fail signal, based on a result of the error correction decoding. The error correction circuitry 138 may use a parity bit, which has been generated during the ECC encoding process for the data stored in the first memory device 150, in order to correct the error bits of the read data entries. When the number of the error bits is greater than or equal to the number of correctable error bits, the error correction circuitry 138 may not correct the error bits and instead may output the correction fail signal indicating failure in correcting the error bits.

According to an embodiment, the error correction circuitry 138 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), or the like.

An operation performed by the ECC decoder, that is, an operation of detecting and correcting errors included in read data, may be an operation distinct from the above-described read retry operation. According to an embodiment, the controller 130 may perform an error correction decoding operation through the ECC decoder when errors equal to or greater than a reference value occur even though the read retry operation, which is a repeated read operation, has been performed using the plurality of read retry levels.

The power management unit (PMU) 140 may control electrical power provided to the controller 130. The PMU 140 may monitor the electrical power supplied to the memory system 110, e.g., a voltage supplied to the controller 130, and provide the electrical power to components included in the controller 130. The PMU 140 may not only detect power-on or power-off, but also generate a trigger signal to enable the memory system 110 to urgently back up a current state when the electrical power supplied to the memory system 110 is unstable. According to an embodiment, the PMU 140 may include a device or a component capable of accumulating electrical power that may be used in an emergency.

The memory interface 142 may serve as an interface for handling commands and data transferred between the controller 130 and the first memory device 150, in order to allow the controller 130 to control the first memory device 150 in response to a command or a request input from the host 102. The memory interface 142 may generate a control signal for the first memory device 150 and may process data input to, or output from, the first memory device 150 under the control of the processor 134 in a case when the first memory device 150 is a flash memory.

For example, when the first memory device 150 includes a NAND flash memory, the memory interface 142 includes a NAND flash controller (NFC). The memory interface 142 can provide an interface for handling commands and data between the controller 130 and the first memory device 150. In accordance with an embodiment, the memory interface 142 can be implemented through, or driven by, firmware called a Flash Interface Layer (FIL) for exchanging data with the first memory device 150.

According to an embodiment, the memory interface 142 may support an open NAND flash interface (ONFi), a toggle mode, or the like, for data input/output with the first memory device 150. For example, the ONFi may use a data path (e.g., a channel, a way, etc.) that includes at least one signal line capable of supporting bi-directional transmission and reception in a unit of 8-bit or 16-bit data. Data communication between the controller 130 and the first memory device 150 can be achieved through at least one interface regarding an asynchronous single data rate (SDR), a synchronous double data rate (DDR), a toggle double data rate (DDR), or the like.

The second memory device 144 may store data for the driving of the storage device 110 and the controller 130. That is, the second memory device 144 may store data that are necessary for the controller 130 to control the external first memory device 150 in response to a request from the host 102.

The processor 134 may control the overall operations of the memory system 110. For example, the processor 134 can control a program operation or a read operation of the first memory device 150 in response to a write request or a read request entered from the host 102.

According to an embodiment, the processor 134 may execute firmware to control the program operation or the read operation in the memory system 110. Herein, the firmware may be referred to as a flash translation layer (FTL). According to an embodiment, the processor 134 may be implemented with a microprocessor, a central processing unit (CPU), or the like.

According to an embodiment, the memory system 110 may be implemented with at least one multi-core processor. The multi-core processor is a type of circuit or chip in which two or more cores, which are considered distinct processing regions, are integrated. For example, when a plurality of cores in the multi-core processor drive or execute a plurality of flash translation layers (FTLs) independently, a data input/output speed (or performance) of the memory system 110 may be improved. According to an embodiment, the data input/output (I/O) operations in the memory system 110 may be independently performed through different cores in the multi-core processor.

The processor 134 controls the entire operations of the memory system 110. In particular, the processor 134 controls a program operation or a read operation for the first memory device 150, in response to a write request or a read request from the host 102. The processor 134 drives firmware which is referred to as a flash translation layer (FTL), to control general operations of the memory system 110. The processor 134 may be realized by a microprocessor or a central processing unit (CPU).

For instance, the controller 130 performs an operation requested from the host 102, in the first memory device 150. That is, the controller 130 performs a command operation corresponding to a command received from the host 102, with the first memory device 150, through the processor 134 embodied by a microprocessor or a central processing unit (CPU). The controller 130 may perform a foreground operation as a command operation corresponding to a command received from the host 102. For example, the controller 130 may perform a program operation corresponding to a write command, a read operation corresponding to a read command, an erase operation corresponding to an erase command.

The controller 130 may also perform a background operation for the first memory device 150, through the processor 134 embodied by a microprocessor or a central processing unit (CPU). The background operation for the first memory device 150 may include an operation of copying data stored in one or more of the storage regions PB<0:7, . . . > of the first memory device 150 to another storage region, for example, a garbage collection (GC) operation. The background operation may include an operation of swapping data between one or more of the storage regions PB<0:7, . . . > of the first memory device 150, for example, a wear leveling (WL) operation, a read reclaim (RR) operation and media scan operation. The background operation may include an operation of storing map data retrieved from the second memory device 144 of the controller 130 in the storage regions PB<0:7, . . . > of the first memory device 150, for example, a map flush operation. The background operation may include a bad management operation for the first memory device 150, which may include checking for and processing a bad storage region among the plurality of storage regions PB<0:7, . . . > in the first memory device 150.

FIGS. 3A to 3G are diagrams illustrating an operation of compressing and managing mapping information in the storage device according to an embodiment of the present disclosure.

Referring to FIGS. 3A to 3G, an operation of generating and managing the compressed mapping table 23A or 23B in the storage device 110 according to an embodiment is illustrated.

Referring to FIG. 3A, the first memory device 150 may include a plurality of storage spaces PB<0:7, . . . >, each of which corresponds to a different one of a plurality of physical addresses PPN.

For example, among the plurality of storage spaces (PB<0:7, . . . >), storage space No. 0 PB0 corresponds to physical address No. 0 PPN 000, storage space No. 1 PB1 corresponds to physical address No. 1 PPN 001, storage space No. 2 PB2 corresponds to physical address No. 2 PPN 010, storage space No. 3 PB3 corresponds to physical address No. 3 PPN 011, storage space No. 4 PB4 corresponds to physical address No. 4 PPN 100, storage space No. 5 PB5 corresponds to physical address No. 5 PPN 101, storage space No. 6 PB6 corresponds to physical address No. 6 PPN 110, and storage space No. 7 PB7 corresponds to physical address No. 7 PPN 111. In this manner, although not illustrated in the drawings, storage space No. 8 PB8 may correspond to physical address No. 8 PPN 1000, storage space No. 16 PB16 may correspond to physical address No. 16 PPN 10000, and storage space No. 32 PB32 may correspond to physical address No. 32 PPN 100000.

Furthermore, the controller 130 may select K physical addresses PPN<000, 001, 010, 011, 100, 101, 110, 111> one by one as target physical addresses TGPPN in a preset order from among the plurality of physical addresses PPN to store write data including K data segments in the first memory device 150. For example, K is a natural number. In an embodiment, K is 8. In the following description, K and 8 may be used interchangeably for the sake of convenience.

For example, to store write data including eight data segments in the first memory device 150, the controller 130 selects and sets eight physical addresses PPN<000, 001, 010, 011, 100, 101, 110, 111> one by one as the target physical addresses TGPPN in a preset order (PPN 000→PPN 001→PPN 010→PPN 011→PPN 100→PPN 101→PPN 110→PPN 111).

The controller 130 may receive at least some of the K logical addresses LPN<000, 001, 010, 011, 100, 101, 110, 111> for a write operation. The controller 130 cannot predict in advance an order in which the K logical addresses LPN<000, 001, 010, 011, 100, 101, 110, 111> are input. For reference, in FIGS. 3A to 3G, all eight logical addresses LPN<000, 001, 010, 011, 100, 101, 110, 111> are input and stored in the address buffer 21 included in the second memory device 144 inside the controller 130.

In an embodiment, as illustrated in the drawings, among the eight logical addresses LPN<000, 001, 010, 011, 100, 101, 110, 111>, logical address No. 5 LPN 101 is input first, followed by logical address No. 1 LPN 001 as a second input, logical address No. 4 LPN 100 as a third input, logical address No. 2 LPN 010 as a fourth input, logical address No. 0 LPN 000 as a fifth input, logical address No. 6 LPN 110 as a sixth input, logical address No. 7 LPN 111 as a seventh input, and logical address No. 3 LPN 011 as an eighth input. In the following description, the symbol corresponding to the received eight logical addresses will be modified to ‘LPN<101, 001, 100, 010, 000, 110, 111, 011>’ according to the input order.

In an embodiment, the storage device 110 prepares the eight physical addresses PPN<000, 001, 010, 011, 100, 101, 110, 111> in response to a single write command inputted from the host 102, and that the eight logical addresses LPN<101, 001, 100, 010, 000, 110, 111, 011> are sequentially inputted. The write command inputted from the host 102 may include information indicating that write data having a size corresponding to eight storage spaces will be inputted for the write operation, and the storage device 110 may analyze the information of the write command and prepare the eight physical addresses PPN<000, 001, 010, 011, 100, 101, 110, 111>.

In an embodiment, the storage device 110, to perform a background operation therein, sequentially inputs the eight logical addresses LPN<101, 001, 100, 010, 000, 110, 111, 011> corresponding to a source storage space into an address buffer 21, and prepares the eight physical addresses PPN<000, 001, 010, 011, 100, 101, 110, 111> corresponding to a target storage space. The storage device 110 selects the source storage space and the target storage space from among the plurality of storage spaces PB<0:7, . . . > included in the first memory device 150, and thereafter performs a write operation for the background operation in which data stored in the source storage space is moved to the target storage space.

Referring to FIG. 3B, the controller 130 may select the eight physical addresses PPN<000, 001, 010, 011, 100, 101, 110, 111> from among the plurality of physical addresses PPN to perform a write operation.

First, the controller 130 may select physical address No. 0 PPN 000 as a first target physical address TGPPN from among the eight physical addresses PPN<000, 001, 010, 011, 100, 101, 110, 111>.

Thereafter, the controller 130 may check an N-bit value included in a designated location of physical address No. 0 PPN 000 selected as the target physical address TGPPN.

The controller 130 may search for and select a target logical address TGLPN of a location including an N-bit value, obtained by applying a preset conversion rule to the N-bit value included in the designated location of the target physical address TGPPN, from among the K logical addresses LPN<101, 001, 100, 010, 000, 110, 111, 011>, at least some of which are received in the address buffer 21 for the write operation.

The preset conversion rule may refer to performing a specific operation, such as adding, subtracting, multiplying, or dividing a certain value, to transform the given value.

In an embodiment, the controller 130 searches for and selects a target logical address TGLPN by determining whether a value obtained by adding 3 to the N-bit value included in the designated location of the target physical address TGPPN is identical to the N-bit value included in the designated location of the target logical address TGLPN. For example, in the case where the N-bit value included in the designated location of the target physical address TGPPN is “00,” the controller 130 performs an addition operation by adding 3 to ‘00’, resulting in ‘11’, and then searches for and selects a target logical address TGLPN of which the N-bit value at the designated location is ‘11’ from among the K logical addresses LPN<101, 001, 100, 010, 000, 110, 111, 011>, at least some of which are received in the address buffer 21.

In an embodiment, the controller 130 searches for and selects a target logical address TGLPN by determining whether a value, obtained by subtracting 2 from the N-bit value included in the designated location of the target physical address TGPPN, is identical to the N-bit value included in the designated location of the target logical address TGLPN. For example, in the case where the N-bit value included in the designated location of the target physical address TGPPN is “11,” the controller 130 may perform a subtraction operation by subtracting 2 from ‘11’, resulting in ‘01’, and then searches for and selects a target logical address TGLPN of which the N-bit value at the designated location is ‘01’ from among the K logical addresses LPN<101, 001, 100, 010, 000, 110, 111, 011>, at least some of which are received in the address buffer 21.

For reference, the following description provides an embodiment in which no operation is performed as a preset conversion rule for the sake of convenience. That is, in the following description, a method is used in which, in the case where the N-bit value included in the designated location of the target physical address TGPPN is ‘00’, the presence of a target logical address TGLPN including ‘00’ in the designated location is searched for.

In the case where the target logical address TGLPN is found among the K logical addresses LPN<101, 001, 100, 010, 000, 110, 111, 011>, at least some of which are received in the address buffer 21 for the write operation, the controller 130 may remove the N-bit value at the designated location of the target physical address TGPPN and generate a target compressed physical address MPPN.

Furthermore, the controller 130 may generate compressed mapping information COMMAP by mapping the target compressed physical address MPPN to the target logical address TGLPN.

For example, N is a natural number.

In an embodiment, N is 2. In the following description, N and 2 may be used interchangeably for the sake of convenience.

Furthermore, the “designated location” of the physical address may be a predetermined position among a plurality of bits included in the physical address.

In an embodiment, the “designated location” of the physical address is a position including two bits from a least significant bit LSB toward higher-order bits among multiple bits included in the physical address. In this case, the 2-bit value included in the designated location of the physical address may refer to a remainder value obtained by converting a plurality of bits included in the physical address into a decimal number and then performing a division operation by 4.

In an embodiment, the “designated location” of the physical address is a position including two bits from a most significant bit MSB toward lower-order bits among a plurality of bits included in the physical address.

Specifically, it can be determined that the lower 2-bit value of physical address No. 0 PPN 000, selected as the target physical address TGPPN, is ‘00’.

The controller 130 may sequentially search, in the order of input, for a logical address, the lower 2-bit value of which is ‘00’, among the eight logical addresses LPN<101, 001, 100, 010, 000, 110, 111, 011> received in the address buffer 21 for the write operation. As a result of the search, it can be determined that the lower 2-bit value of logical address No. 4 LPN 100, which is positioned third among the eight logical addresses LPN<101, 001, 100, 010, 000, 110, 111, 011>, is ‘00’. Therefore, the controller 130 may select logical address No. 4 LPN 100 as the target logical address TGLPN.

In this way, as the target logical address TGLPN is selected, the controller 130 may remove the lower 2-bit value of physical address No. 0 PPN 000 selected as the target physical address TGPPN, thus generating a compressed physical address MPPN 0.

Furthermore, the controller 130 may generate first compressed mapping information COMMAP<0> by mapping logical address No. 4 LPN 100, selected as the target logical address TGLPN, to the compressed physical address MPPN 0.

Referring to FIG. 3C, the controller 130 may select physical address No. 1 PPN 001 as a second target physical address TGPPN from among the eight physical addresses PPN<000, 001, 010, 011, 100, 101, 110, 111>.

Thereafter, the controller 130 may check the 2-bit value included in the designated location of physical address No. 1 PPN 001 selected as the target physical address TGPPN. The controller 130 may determine that the lower 2-bit value of physical address No. 1 PPN 001 selected as the target physical address TGPPN is ‘01’.

The controller 130 may search for and select a target logical address TGLPN of a location including a 2-bit value, obtained by applying the preset conversion rule to the 2-bit value included in the designated location of the target physical address TGPPN, from among the eight logical addresses LPN<101, 001, 100, 010, 000, 110, 111, 011>, at least some of which are received in the address buffer 21 for the write operation. Logical address No. 4 LPN 100, which is previously selected as the target logical address TGLPN in FIG. 3B, may be excluded from the search target. The controller 130 may search for a target logical address TGLPN of the location including the 2-bit value, obtained by applying the preset conversion rule to the 2-bit value included in the designated location of the target physical address TGPPN, from among the seven logical addresses LPN<101, 001, 010, 000, 110, 111, 011>.

Specifically, the controller 130 may search, as the target logical address TGLPN, for a logical address, the lower 2-bit value of which is ‘01’, from among the seven logical addresses LPN<101, 001, 010, 000, 110, 111, 011> in the order of the input thereof into the address buffer 21. As a result of the search, it can be determined that the lower 2-bit value of logical address No. 5 LPN 101, which is positioned first among the seven logical addresses LPN<101, 001, 010, 000, 110, 111, 011>, is ‘01’. Therefore, the controller 130 may select logical address No. 5 LPN 101 as the target logical address TGLPN.

In this way, as the target logical address TGLPN is selected, the controller 130 may remove the lower 2-bit value of physical address No. 1 PPN 001 selected as the target physical address TGPPN, thus generating a compressed physical address MPPN 0.

Furthermore, the controller 130 may generate second compressed mapping information COMMAP<1> by mapping logical address No. 5 LPN 101, selected as the target logical address TGLPN, to the compressed physical address MPPN 1.

Referring to FIG. 3D, the controller 130 may select physical address No. 2 PPN 010 as a third target physical address TGPPN from among the eight physical addresses PPN<000, 001, 010, 011, 100, 101, 110, 111>.

Thereafter, the controller 130 may check the 2-bit value included in the designated location of physical address No. 2 PPN 010 selected as the target physical address TGPPN. The controller 130 may determine that the lower 2-bit value of physical address No. 2 PPN 010 selected as the target physical address TGPPN is ‘10’.

The controller 130 may search for and select a target logical address TGLPN of a location including a 2-bit value, obtained by applying the preset conversion rule to the 2-bit value included in the designated location of the target physical address TGPPN, from among the eight logical addresses LPN<101, 001, 100, 010, 000, 110, 111, 011>, at least some of which are received in the address buffer 21 for the write operation. Logical address No. 4 LPN 100 and logical address No. 5 LPN 101, which are previously selected as the target logical address TGLPN in FIGS. 3B and 3C, may be excluded from the search target. The controller 130 may search for the target logical address TGLPN of the location including the 2-bit value, obtained by applying the preset conversion rule to the 2-bit value included in the designated location of the target physical address TGPPN, from among the six logical addresses LPN<001, 010, 000, 110, 111, 011>.

Specifically, the controller 130 may search, as the target logical address TGLPN, for a logical address, the lower 2-bit value of which is ‘10’, from among the six logical addresses LPN<001, 010, 000, 110, 111, 011> in the order of the input thereof into the address buffer 21. As a result of the search, it can be determined that the lower 2-bit value of logical address No. 2 LPN 010, which is positioned second among the six logical addresses LPN<001, 010, 000, 110, 111, 011>, is ‘10’. Therefore, the controller 130 may select logical address No. 2 LPN 010 as the target logical address TGLPN.

In this way, as the target logical address TGLPN is selected, the controller 130 may remove the lower 2-bit value of physical address No. 2 PPN 010 selected as the target physical address TGPPN, thus generating a compressed physical address MPPN 0.

Furthermore, the controller 130 may generate third compressed mapping information COMMAP<2> by mapping logical address No. 2 LPN 010, selected as the target logical address TGLPN, to the compressed physical address MPPN 2.

Referring to FIG. 3E, in the same manner as described with reference to FIGS. 3B to 3D, the controller 130 may sequentially select each of the eight physical addresses PPN<000, 001, 010, 011, 100, 101, 110, 111> one by one as the target physical address TGPPN. The controller 130 may sequentially select the eight target physical addresses TGPPN one by one.

Furthermore, each time each of the eight physical addresses PPN<000, 001, 010, 011, 100, 101, 110, 111> is selected as the target physical address TGPPN, the controller 130 may search for a target logical address TGLPN of a location including an N-bit value, obtained by applying the preset conversion rule to the N-bit value included in the designated location in the target physical address TGPPN, from among the logical addresses LPN<101, 001, 100, 010, 000, 110, 111, 011> stored in the address buffer 21, and may select the searched target logical address TGLPN. The controller 130 may select the eight target logical addresses TGLPN, each corresponding to a different one of the eight target physical addresses TGPPN.

Specifically, as shown in the drawings, in the case where physical address No. 0 PPN 000 selected first from among the eight physical addresses PPN<000, 001, 010, 011, 100, 101, 110, 111> is selected as the target physical address TGPPN, logical address No. 4 LPN 100 among the eight logical addresses LPN<101, 001, 100, 010, 000, 110, 111, 011> may be selected as the target logical address TGLPN. Therefore, first compressed mapping information COMMAP<0> may be generated by mapping a compressed physical address MPPN 0 obtained by excluding the lower 2 bits from physical address No. 0 PPN 000, to logical address No. 4 LPN 100.

Furthermore, the controller 130 may also manage a P2L form of the first compressed mapping information COMMAP<0>, which is generated in an L2P form, by mapping the compressed logical address MLPN 1 obtained by excluding the lower 2 bits from logical address No. 4 LPN 100, to physical address No. 0 PPN 000.

Furthermore, as shown in the drawings, in the case where physical address No. 1 PPN 001 selected second from among the eight physical addresses PPN<000, 001, 010, 011, 100, 101, 110, 111> is selected as the target physical address TGPPN, logical address No. 5 LPN 101 among the eight logical addresses LPN<101, 001, 100, 010, 000, 110, 111, 011> may be selected as the target logical address TGLPN. Therefore, second compressed mapping information COMMAP<1> may be generated by mapping a compressed physical address MPPN 0 obtained by excluding the lower 2 bits from physical address No. 1 PPN 001, to logical address No. 5 LPN 101.

In addition, the controller 130 may also manage a P2L form of the second compressed mapping information COMMAP<1>, which is generated in an L2P form, by mapping the compressed logical address MLPN 1 obtained by excluding the lower 2 bits from logical address No. 5 LPN 101, to physical address No. 1 PPN 001.

Furthermore, as shown in the drawings, in the case where physical address No. 2 PPN 010 selected third from among the eight physical addresses PPN<000, 001, 010, 011, 100, 101, 110, 111> is selected as the target physical address TGPPN, logical address No. 2 LPN 010 among the eight logical addresses LPN<101, 001, 100, 010, 000, 110, 111, 011> may be selected as the target logical address TGLPN. Therefore, third compressed mapping information COMMAP<2> may be generated by mapping a compressed physical address MPPN 0 obtained by excluding the lower 2 bits from physical address No. 2 PPN 010, to logical address No. 2 LPN 010.

In addition, the controller 130 may also manage a P2L form of the third compressed mapping information COMMAP<2>, which is generated in an L2P form, by mapping the compressed logical address MLPN 0 obtained by excluding the lower 2 bits from logical address No. 2 LPN 010, to physical address No. 2 PPN 010.

Furthermore, as shown in the drawings, in the case where physical address No. 3 PPN 011 selected fourth from among the eight physical addresses PPN<000, 001, 010, 011, 100, 101, 110, 111> is selected as the target physical address TGPPN, logical address No. 7 LPN 111 among the eight logical addresses LPN<101, 001, 100, 010, 000, 110, 111, 011> may be selected as the target logical address TGLPN. Therefore, fourth compressed mapping information COMMAP<3> may be generated by mapping a compressed physical address MPPN 0 obtained by excluding the lower 2 bits from physical address No. 3 PPN 011, to logical address No. 7 LPN 111.

In addition, the controller 130 may also manage a P2L form of the fourth compressed mapping information COMMAP<3>, which is generated in an L2P form, by mapping the compressed logical address MLPN 1 obtained by excluding the lower 2 bits from logical address No. 7 LPN 111, to physical address No. 3 PPN 011.

Furthermore, as shown in the drawings, in the case where physical address No. 4 PPN 100 selected fifth from among the eight physical addresses PPN<000, 001, 010, 011, 100, 101, 110, 111> is selected as the target physical address TGPPN, logical address No. 0 LPN 000 among the eight logical addresses LPN<101, 001, 100, 010, 000, 110, 111, 011> may be selected as the target logical address TGLPN. Therefore, fifth compressed mapping information COMMAP<4> may be generated by mapping a compressed physical address MPPN 1 obtained by excluding the lower 2 bits from physical address No. 4 PPN 100, to logical address No. 0 LPN 000.

Furthermore, the controller 130 may also manage a P2L form of the fifth compressed mapping information COMMAP<4>, which is generated in an L2P form, by mapping the compressed logical address MLPN 0 obtained by excluding the lower 2 bits from logical address No. 0 LPN 000, to physical address No. 4 PPN 100.

Furthermore, as shown in the drawings, in the case where physical address No. 5 PPN 101 selected sixth from among the eight physical addresses PPN<000, 001, 010, 011, 100, 101, 110, 111> is selected as the target physical address TGPPN, logical address No. 1 LPN 001 among the eight logical addresses LPN<101, 001, 100, 010, 000, 110, 111, 011> may be selected as the target logical address TGLPN. Therefore, sixth compressed mapping information COMMAP<5> may be generated by mapping a compressed physical address MPPN 1 obtained by excluding the lower 2 bits from physical address No. 5 PPN 101, to logical address No. 1 LPN 001.

In addition, the controller 130 may manage a P2L form of the sixth compressed mapping information COMMAP<5>, which is generated in an L2P form, by mapping the compressed logical address MLPN 0 obtained by excluding the lower 2 bits from logical address No. 1 LPN 001, to physical address No. 5 PPN 101.

Furthermore, as shown in the drawings, in the case where physical address No. 6 PPN 110 selected seventh from among the eight physical addresses PPN<000, 001, 010, 011, 100, 101, 110, 111> is selected as the target physical address TGPPN, logical address No. 6 LPN 110 among the eight logical addresses LPN<101, 001, 100, 010, 000, 110, 111, 011> may be selected as the target logical address TGLPN. Therefore, seventh compressed mapping information COMMAP<6> may be generated by mapping a compressed physical address MPPN 1 obtained by excluding the lower 2 bits from physical address No. 6 PPN 110, to logical address No. 6 LPN 110.

In addition, the controller 130 may manage a P2L form of the seventh compressed mapping information COMMAP<6>, which is generated in an L2P form, by mapping the compressed logical address MLPN 1 obtained by excluding the lower 2 bits from logical address No. 6 LPN 110, to physical address No. 6 PPN 110.

Furthermore, as shown in the drawings, in the case where physical address No. 7 PPN 111 selected eighth from among the eight physical addresses PPN<000, 001, 010, 011, 100, 101, 110, 111> is selected as the target physical address TGPPN, logical address No. 3 LPN 011 among the eight logical addresses LPN<101, 001, 100, 010, 000, 110, 111, 011> may be selected as the target logical address TGLPN. Therefore, eighth compressed mapping information COMMAP<7> may be generated by mapping a compressed physical address MPPN 1 obtained by excluding the lower 2 bits from physical address No. 7 PPN 111, to logical address No. 3 LPN 011.

In addition, the controller 130 may manage a P2L form of the eighth compressed mapping information COMMAP<7>, which is generated in an L2P form, by mapping the compressed logical address MLPN 0 obtained by excluding the lower 2 bits from logical address No. 3 LPN 011, to physical address No. 7 PPN 111.

As such, the controller 130 may generate the eight pieces of compressed mapping information COMMAP<0:7> by mapping each of the eight physical addresses PPN<000, 001, 010, 011, 100, 101, 110, 111> to a corresponding one of the eight logical addresses LPN<101, 001, 100, 010, 000, 110, 111, 011> in the aforementioned manner.

The controller 130 may arrange and manage the eight pieces of compressed mapping information COMMAP<0:7> as the compressed mapping table 23A or 23B. The controller 130 may generate and manage the L2P information, which defines the values of the compressed physical addresses MPPN based on the normal logical addresses NLPN, and P2L information, which defines the values of the compressed logical addresses MLPN based on the value of the normal physical addresses NPPN, for the eight pieces of compressed mapping information COMMAP<0:7>.

Referring to FIG. 3F, the controller 130 may receive the eight pieces of write data WD<0:7> corresponding to eight normal logical addresses NLPN<000, 001, 010, 011, 100, 101, 110, 111> for a write operation, into the data buffer 22.

For example, the operation of generating the compressed mapping table 23A or 23B in the controller 130, as described with reference to FIGS. 3B to 3E, and the operation of receiving the eight pieces of write data WD<0:7> into the data buffer 22 may be performed in parallel. After the eight logical addresses LPN<101, 001, 100, 010, 000, 110, 111, 011> for the write operation are inputted to the address buffer 21, the eight pieces of write data WD<0:7> may be inputted into the data buffer 22 while the controller 130 performs the operation of generating the compressed mapping table 23A or 23B.

Specifically, with reference to the L2P information included in the compressed mapping table 23A or 23B, that is, the eight compressed physical addresses MPPN<1, 1, 0, 1, 0, 0, 1, 0> mapped to the eight normal logical addresses NLPN<000, 001, 010, 011, 100, 101, 110, 111>, the controller 130 may determine the eight normal physical addresses NPPN<100, 101, 010, 111, 000, 001, 110, 011> corresponding to the eight normal logical addresses NLPN<000, 001, 010, 011, 100, 101, 110, 111>.

The controller 130 may determine the eight normal physical addresses NPPN<100, 101, 010, 111, 000, 001, 110, 011> that respectively correspond to the eight normal logical addresses NLPN<000, 001, 010, 011, 100, 101, 110, 111> by appending the lower 2-bit value of each of the eight normal logical addresses NLPN<000, 001, 010, 011, 100, 101, 110, 111> to a corresponding one of the eight compressed physical addresses MPPN<1, 1, 0, 1, 0, 0, 1, 0> as the lower 2-bit value of the corresponding one.

Therefore, the controller 130 may determine eight storage spaces PB<4, 5, 2, 7, 0, 1, 6, 3> that respectively correspond to the eight normal logical addresses NLPN<000, 001, 010, 011, 100, 101, 110, 111>.

Therefore, the controller 130 may store each of the eight pieces of write data WD<0:7> in a corresponding one of the eight storage spaces PB<4, 5, 2, 7, 0, 1, 6, 3>, which respectively correspond to the eight normal logical addresses NLPN<000, 001, 010, 011, 100, 101, 110, 111>.

Furthermore, the controller 130 may store each of the eight pieces of write data WD<0:7> in a corresponding one of respective data sectors DSEC of the eight storage spaces PB<4, 5, 2, 7, 0, 1, 6, 3>, which respectively correspond to the eight normal logical addresses NLPN<000, 001, 010, 011, 100, 101, 110, 111>, and may store each of eight compressed logical addressees MLPN<0, 0, 0, 0, 1, 1, 1, 1> in a corresponding one of spare sectors SSEC. As each of the eight compressed logical addresses MLPN<0, 0, 0, 0, 1, 1, 1, 1> is stored in a corresponding one of the respective spare sectors SSEC of the eight storage spaces PB<4, 5, 2, 7, 0, 1, 6, 3>, which respectively correspond to the eight normal logical addresses NLPN<000, 001, 010, 011, 100, 101, 110, 111>, the controller 130 may perform operations such as recovering the compressed logical addresses MLPN<0, 0, 0, 0, 1, 1, 1, 1> into the normal logical addresses NLPN<000, 001, 010, 011, 100, 101, 110, 111> and generating a normal mapping table 24 during an operation such as sudden power off recovery (SPOR).

In summary, in response to selecting each of the eight normal logical addresses NLPN<000, 001, 010, 011, 100, 101, 110, 111> once each, for a total of eight times, as the target logical address TGLPN, the controller 130 may store each of the eight pieces of write data WD<0:7> in a corresponding one of the target storage spaces, i.e., the eight storage spaces PB<4, 5, 2, 7, 0, 1, 6, 3>, which are respectively indicated by the eight normal physical addresses NPPN<100, 101, 010, 111, 000, 001, 110, 011> selected as the target physical addresses TGPPN. Furthermore, the controller 130 may store each of the eight pieces of write data WD<0:7> in a corresponding one of the target storage spaces, i.e., the respective data sectors DSEC of the eight storage spaces PB<4, 5, 2, 7, 0, 1, 6, 3>, and may store each of the eight compressed logical address MLPN<0, 0, 0, 0, 1, 1, 1, 1> in a corresponding one of the spare sectors SSEC.

More specifically, with reference to the compressed mapping table 23A or 23B, the controller 130 may recover the compressed physical address MPPN 1 mapped to normal logical address No. 0 NLPN 000, and determine that the recovered value corresponds to normal physical address No. 4 NPPN 100. The controller 130 may perform a recovery operation of appending the lower 2-bit value ‘00’ of normal logical address No. 0 NLPN 000 to the lower 2-bit value of the compressed physical address MPPN 1 mapped to normal logical address No. 0 NLPN 000, and may determine that the resulting value corresponds to normal physical address No. 4 NPPN 100.

Accordingly, the controller 130 may store write data No. 0 WD0, which corresponds to normal logical address No. 0 NLPN 000, in storage space No. 4 PB4, which corresponds to normal physical address No. 4 NPPN 100. The controller 130 may store write data No. 0 WD0 in the data sector DSEC of storage space No. 4 PB4, and store the compressed logical address MLPN 0, obtained by removing the lower 2-bit value from normal logical address No. 0 NLPN 000, in the spare sector SSEC of storage space No. 4 PB4.

Furthermore, with reference to the compressed mapping table 23A or 23B, the controller 130 may recover the compressed physical address MPPN 1 mapped to normal logical address No. 1 NLPN 001, and determine that the recovered value corresponds to normal physical address No. 5 NPPN 101. The controller 130 may perform a recovery operation of appending the lower 2-bit value ‘01’ of normal logical address No. 1 NLPN 001 to the lower 2-bit value of the compressed physical address MPPN 1 mapped to normal logical address No. 1 NLPN 001, and may determine that the resulting value corresponds to normal physical address No. 5 NPPN 101.

Accordingly, the controller 130 may store write data No. 1 WD1, which corresponds to normal logical address No. 1 NLPN 001, in storage space No. 5 PB5, which corresponds to normal physical address No. 5 NPPN 101. The controller 130 may store write data No. 1 WD1 in the data sector DSEC of storage space No. 5 PB5, and store the compressed logical address MLPN 0, obtained by removing the lower 2-bit value from normal logical address No. 1 NLPN 001, in the spare sector SSEC of storage space No. 5 PB5.

Furthermore, with reference to the compressed mapping table 23A or 23B, the controller 130 may recover the compressed physical address MPPN 0 mapped to normal logical address No. 2 NLPN 010, and determine that the recovered value corresponds to normal physical address No. 2 NPPN 010. The controller 130 may perform a recovery operation of appending the lower 2-bit value ‘10’ of normal logical address No. 2 NLPN 010 to the lower 2-bit value of the compressed physical address MPPN 0 mapped to normal logical address No. 2 NLPN 010, and may determine that the resulting value corresponds to normal physical address No. 2 NPPN 010.

Accordingly, the controller 130 may store write data No. 2 WD2, which corresponds to normal logical address No. 2 NLPN 010, in storage space No. 2 PB2, which corresponds to normal physical address No. 2 NPPN 010. The controller 130 may store write data No. 2 WD2 in the data sector DSEC of storage space No. 2 PB2, and store the compressed logical address MLPN 0, obtained by removing the lower 2-bit value from normal logical address No. 2 NLPN 010, in the spare sector SSEC of storage space No. 2 PB2.

Furthermore, with reference to the compressed mapping table 23A or 23B, the controller 130 may recover the compressed physical address MPPN 1 mapped to normal logical address No. 3 NLPN 011, and determine that the recovered value corresponds to normal physical address No. 7 NPPN 111. The controller 130 may perform a recovery operation of appending the lower 2-bit value ‘11’ of normal logical address No. 3 NLPN 011 to the lower 2-bit value of the compressed physical address MPPN 1 mapped to normal logical address No. 3 NLPN 011, and may determine that the resulting value corresponds to normal physical address No. 7 NPPN 111.

Accordingly, the controller 130 may store write data No. 3 WD3, which corresponds to normal logical address No. 3 NLPN 011, in storage space No. 7 PB7, which corresponds to normal physical address No. 7 NPPN 111. The controller 130 may store write data No. 3 WD3 in the data sector DSEC of storage space No. 7 PB7, and store the compressed logical address MLPN 0, obtained by removing the lower 2-bit value from normal logical address No. 3 NLPN 011, in the spare sector SSEC of storage space No. 7 PB7.

Furthermore, with reference to the compressed mapping table 23A or 23B, the controller 130 may recover the compressed physical address MPPN 0 mapped to normal logical address No. 4 NLPN 100, and determine that the recovered value corresponds to normal physical address No. 0 NPPN 000. The controller 130 may perform a recovery operation of appending the lower 2-bit value ‘00’ of normal logical address No. 4 NLPN 100 to the lower 2-bit value of the compressed physical address MPPN 0 mapped to normal logical address No. 4 NLPN 100, and may determine that the resulting value corresponds to normal physical address No. 0 NPPN 000.

Accordingly, the controller 130 may store write data No. 4 WD4, which corresponds to normal logical address No. 4 NLPN 100, in storage space No. 0 PB0, which corresponds to normal physical address No. 0 NPPN 000. The controller 130 may store write data No. 4 WD4 in the data sector DSEC of storage space No. 0 PB0, and store the compressed logical address MLPN 1, obtained by removing the lower 2-bit value from normal logical address No. 4 NLPN 100, in the spare sector SSEC of storage space No. 0 PB0.

Furthermore, with reference to the compressed mapping table 23A or 23B, the controller 130 may recover the compressed physical address MPPN 0 mapped to normal logical address No. 5 NLPN 101 and determine that the recovered value corresponds to normal physical address No. 1 NPPN 001. The controller 130 may perform a recovery operation of appending the lower 2-bit value ‘01’ of normal logical address No. 5 NLPN 101 to the lower 2-bit value of the compressed physical address MPPN 0 mapped to normal logical address No. 5 NLPN 101, and may determine that the resulting value corresponds to normal physical address No. 1 NPPN 001.

Accordingly, the controller 130 may store write data No. 5 WD5, which corresponds to normal logical address No. 5 NLPN 101, in storage space No. 1 PB1, which corresponds to normal physical address No. 1 NPPN 001. The controller 130 may store write data No. 5 WD5 in the data sector DSEC of storage space No. 1 PB1, and store the compressed logical address MLPN 1, obtained by removing the lower 2-bit value from normal logical address No. 5 NLPN 101, in the spare sector SSEC of storage space No. 1 PB1.

Furthermore, with reference to the compressed mapping table 23A or 23B, the controller 130 may recover the compressed physical address MPPN 1 mapped to normal logical address No. 6 NLPN 110, and determine that the recovered value corresponds to normal physical address No. 6 NPPN 110. The controller 130 may perform a recovery operation of appending the lower 2-bit value ‘10’ of normal logical address No. 6 NLPN 110 to the lower 2-bit value of the compressed physical address MPPN 1 mapped to normal logical address No. 6 NLPN 110, and may determine that the resulting value corresponds to normal physical address No. 6 NPPN 110.

Accordingly, the controller 130 may store write data No. 6 WD6, which corresponds to normal logical address No. 6 NLPN 110, in storage space No. 6 PB6, which corresponds to normal physical address No. 6 NPPN 110. The controller 130 may store write data No. 6 WD6 in the data sector DSEC of storage space No. 6 PB6, and store the compressed logical address MLPN 1, obtained by removing the lower 2-bit value from normal logical address No. 6 NLPN 110, in the spare sector SSEC of storage space No. 6 PB6.

Furthermore, with reference to the compressed mapping table 23A or 23B, the controller 130 may recover the compressed physical address MPPN 0 mapped to normal logical address No. 7 NLPN 111, and determine that the recovered value corresponds to normal physical address No. 3 NPPN 011. The controller 130 may perform a recovery operation of appending the lower 2-bit value ‘11’ of normal logical address No. 7 NLPN 111 to the lower 2-bit value of the compressed physical address MPPN 0 mapped to normal logical address No. 7 NLPN 111, and may determine that the resulting value corresponds to normal physical address No. 3 NPPN 011.

Accordingly, the controller 130 may store write data No. 7 WD7, which corresponds to normal logical address No. 7 NLPN 111, in storage space No. 3 PB3, which corresponds to normal physical address No. 3 NPPN 011. The controller 130 may store write data No. 7 WD7 in the data sector DSEC of storage space No. 3 PB3, and store the compressed logical address MLPN 1, obtained by removing the lower 2-bit value from normal logical address No. 7 NLPN 111, in the spare sector SSEC of storage space No. 3 PB3.

Referring to FIG. 3G, an operation is illustrated for the case where a read logical address READ LPN is received in a state where K pieces of write data WD<0:7> are stored in K storage spaces among the plurality of storage spaces PB<0:7, . . . > included in the first memory device 150 through the operations described with reference to FIGS. 3A to 3F.

Upon input of the read logical address READ LPN into the address buffer 21, the controller 130 may search for a compressed physical address MPPN corresponding to the read logical address READ LPN with reference to the compressed mapping table 23A or 23B.

In the case where the compressed physical address MPPN corresponding to the read logical address READ LPN is searched for from the compressed mapping table 23A or 23B, the controller 130 may determine, as the read logical address, the value of the normal physical address NPPN that is obtained by appending an N-bit value at a designated location of the read logical address READ LPN to the designated location of the searched compressed physical address MPPN.

The controller 130 may read data stored in a specific storage space corresponding to the read logical address among the plurality of storage spaces included in the first memory device 150.

In an embodiment, a read logical address READ LPN having the value ‘111’ is inputted to the address buffer 21 in a state where the eight pieces of write data WD<0:7> are stored in the eight storage spaces among the plurality of storage spaces PB<0:7, . . . > included in the first memory device 150 through the operations described with reference to FIGS. 3A to 3F, however, other values may be used.

The controller 130 may determine that the compressed physical address MPPN mapped to the normal logical address NLPN 111, which has a read logical address value of ‘111’, is ‘0’ among the eight normal logical addresses NLPN<000, 001, 010, 011, 100, 101, 110, 111> included in the compressed mapping table 23A or 23B, and may append the lower 2-bit value ‘11’ of the read logical address value ‘111’ to the lower 2 bits of the compressed physical address MPPN, which has the value ‘0’, thereby determining the normal physical address NPPN having the value ‘011’. Therefore, the controller 130 may read the data WD7 stored in storage space No. 3 PB3, which corresponds to the normal physical address NPPN having the value ‘011’.

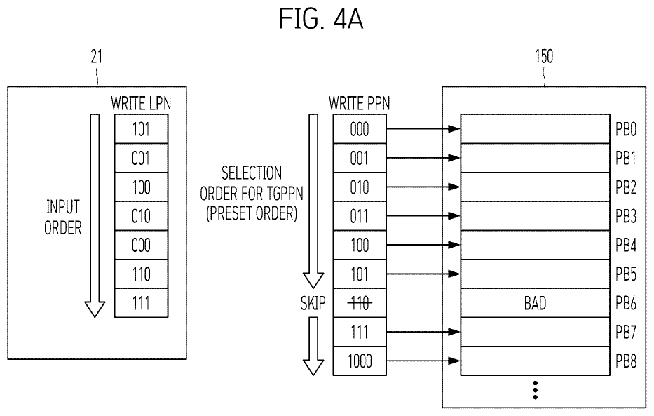

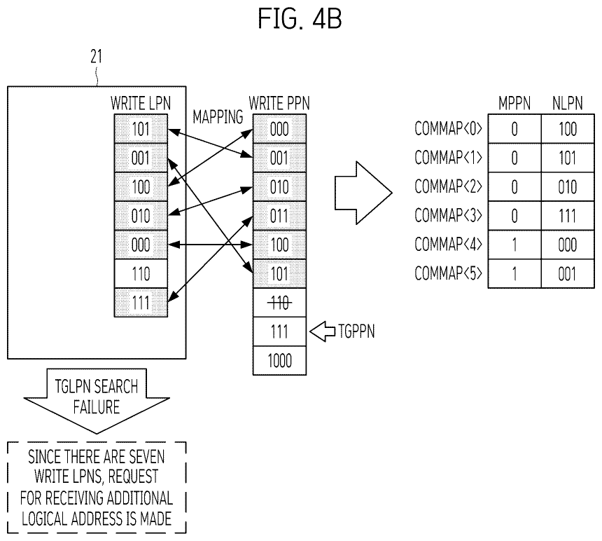

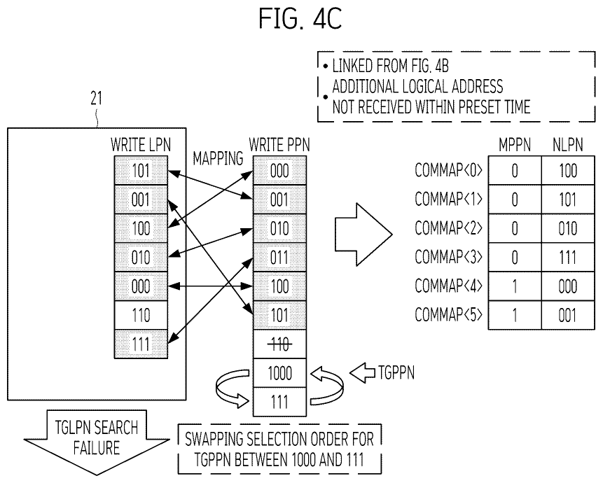

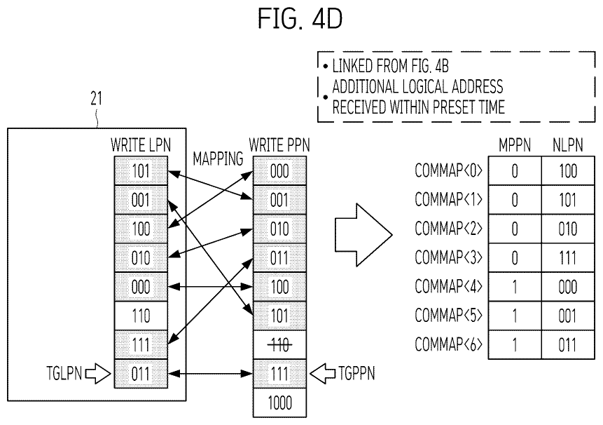

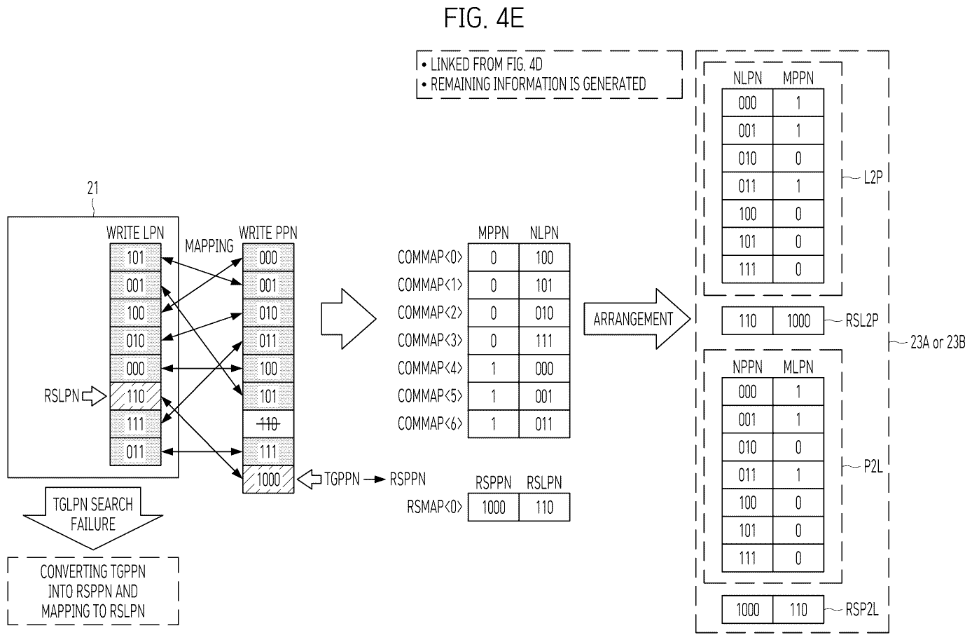

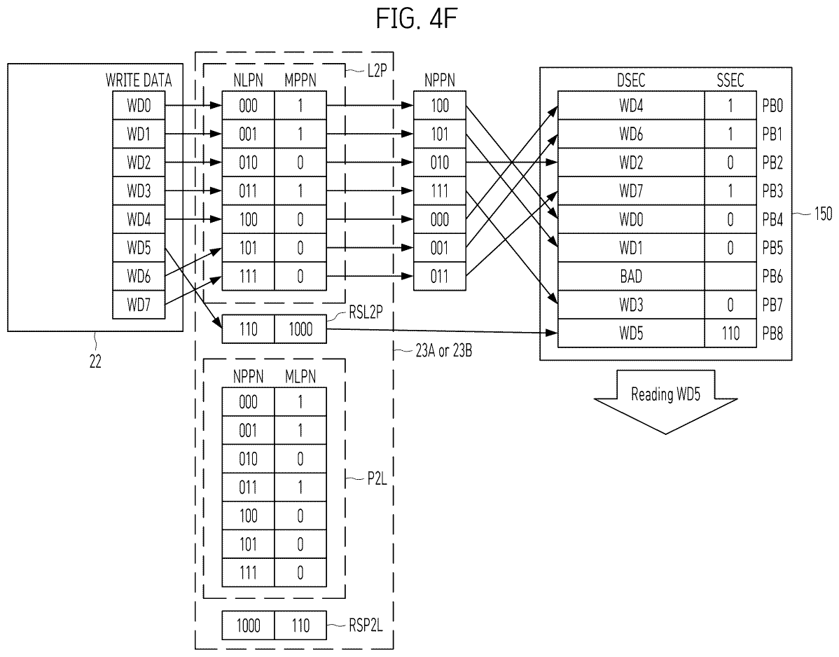

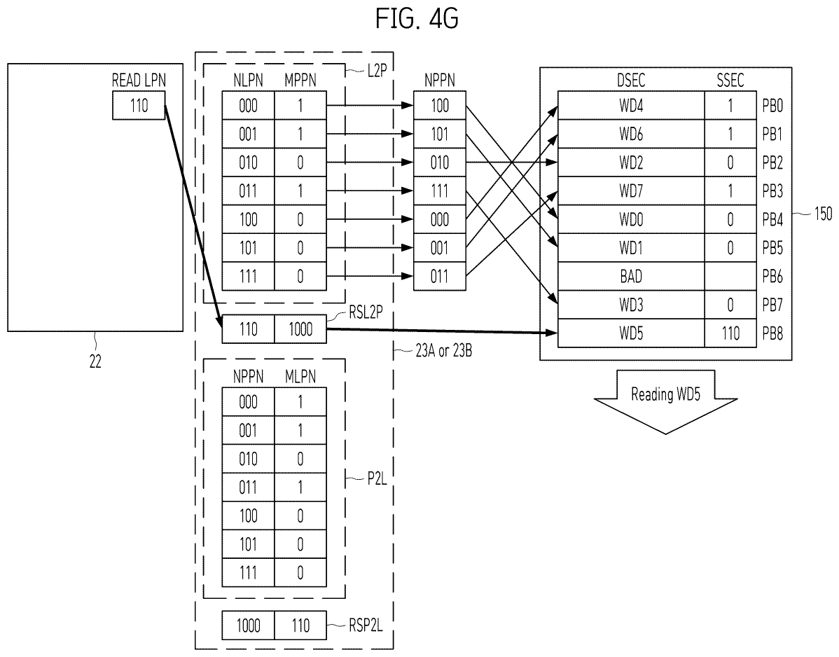

FIGS. 4A to 4G are diagrams illustrating an operation of compressing and storing mapping information in the storage device according to an embodiment of the present disclosure.

Referring to FIGS. 4A to 4G, an operation of generating and managing the compressed mapping table 23A or 23B in the storage device 110 according to an embodiment is illustrated.

Referring to FIG. 4A, the first memory device 150 may include a plurality of storage spaces PB<0:7, . . . >, each of which corresponds to a different one of a plurality of physical addresses PPN.

For example, among the plurality of storage spaces (PB<0:7, . . . >), storage space No. 0 PB0 corresponds to physical address No. 0 PPN 000, storage space No. 1 PB1 corresponds to physical address No. 1 PPN 001, storage space No. 2 PB2 corresponds to physical address No. 2 PPN 010, storage space No. 3 PB3 corresponds to physical address No. 3 PPN 011, storage space No. 4 PB4 corresponds to physical address No. 4 PPN 100, storage space No. 5 PB5 corresponds to physical address No. 5 PPN 101, storage space No. 6 PB6 corresponds to physical address No. 6 PPN 110, storage space No. 7 PB7 corresponds to physical address No. 7 PPN 111, and storage space No. 8 PB8 corresponds to physical address No. 8 PPN 1000. For example, storage space No. 6 PB6 among the plurality of storage spaces PB<0:7, . . . > is in a bad state BAD. That is, storage space No. 6 PB6 may be in a state where data cannot be stored.

Furthermore, the controller 130 may sequentially select each of the eight physical addresses PPN<000, 001, 010, 011, 100, 101, 111, 1000> as a target physical address TGPPN according to a preset order from among the plurality of physical addresses PPN to store write data including 8 data segments in the first memory device 150. Because storage space No. 6 PB6 is in a bad state BAD, the controller 130 does not use physical address No. 6 PPN 110, which indicates storage space No. 6 PB6, to store write data. The controller 130 may sequentially select each of physical addresses No. 0 to No. 5 (PPN 000→PPN 001→PPN 010→PPN 011→PPN 100→PPN 101) from among the plurality of physical addresses PPN, skip physical address No. 6 PPN 110, and sequentially select each of physical addresses No. 7 and No. 8 (PPN 111→PPN 1000), thus setting the selected physical addresses as target physical addresses TGPPN.

In the drawing, the controller 130 may be in a state where seven logical addresses LPN<101, 001, 100, 010, 000, 110, 111> among the eight logical addresses LPN<000, 001, 010, 011, 100, 101, 110, 111> for a write operation are received and stored in the address buffer 21.

Referring to FIG. 4B, in the same manner as described with reference to FIGS. 3B to 3E, the controller 130 may be in a state where each of six physical addresses (PPN<000, 001, 010, 011, 100, 101>) among the eight physical addresses (PPN<000, 001, 010, 011, 100, 101, 111, 1000>) prepared for the write operation are sequentially selected as a target physical address TGPPN, and corresponding target logical addresses TGLPN are searched for and selected. Subsequently, the controller 130 may be in a state where the seventh physical address PPN 111 is selected as the target physical address TGPPN, and a search for the corresponding target logical address TGLPN is performed but the corresponding target logical address TGLPN is not found.

Specifically, each time each of the seven physical addresses PPN<000, 001, 010, 011, 100, 101, 111> among the eight physical addresses PPN<000, 001, 010, 011, 100, 101, 111, 1000> prepared for the write operation is selected as the target physical address TGPPN, the controller 130 may search for a target logical address TGLPN of a location including a 2-bit value, obtained by applying a preset conversion rule to a 2-bit value included in a designated location in the target physical address TGPPN, from among the seven logical addresses LPN<101, 001, 100, 010, 000, 110, 111> stored in the address buffer 21, and may select the searched target logical address TGLPN.

As shown in the drawing, the controller 130 may map physical address No. 0 PPN 000 to logical address No. 4 LPN 100, and accordingly, generate first compressed mapping information COMMAP<0> by mapping compressed physical address MPPN 0, which is obtained by removing the lower 2-bits from physical address No. 0 PPN 000, to logical address No. 4 LPN 100.

Furthermore, the controller 130 may map physical address No. 1 PPN 001 to logical address No. 5 LPN 101, and accordingly, generate second compressed mapping information COMMAP<1> by mapping compressed physical address MPPN 0, which is obtained by removing the lower 2-bits from physical address No. 1 PPN 001, to logical address No. 5 LPN 101.

The controller 130 may map physical address No. 2 PPN 010 to logical address No. 2 LPN 010, and accordingly, generate third compressed mapping information COMMAP<2> by mapping compressed physical address MPPN 0, which is obtained by removing the lower 2-bits from physical address No. 2 PPN 010, to logical address No. 2 LPN 010.

The controller 130 may map physical address No. 3 PPN 011 to logical address No. 7 LPN 111, and accordingly, generate fourth compressed mapping information COMMAP<3> by mapping compressed physical address MPPN 0, which is obtained by removing the lower 2-bits from physical address No. 3 PPN 011, to logical address No. 7 LPN 111.

The controller 130 may map physical address No. 4 PPN 100, which is selected fifth, to logical address No. 0 LPN 000, and accordingly, generate fifth compressed mapping information COMMAP<4> by mapping compressed physical address MPPN 1, which is obtained by removing the lower 2-bits from physical address No. 4 PPN 100, to logical address No. 0 LPN 000.

The controller 130 may map physical address No. 5 PPN 101 to logical address No. 1 LPN 001, and accordingly, generate sixth compressed mapping information COMMAP<5> by mapping compressed physical address MPPN 1, which is obtained by removing the lower 2-bits from physical address No. 5 PPN 101, to logical address No. 1 LPN 001.

Subsequently, the controller 130 may select physical address No. 7 PPN 111 as the target physical address TGPPN, and determine whether logical address No. 6 LPN 110, which has not been selected as the target logical address TGLPN, among the seven logical addresses LPN<101, 001, 100, 010, 000, 110, 111>, can be set as the target logical address TGLPN. As a result of the determination, the lower 2-bit value of physical address No. 7 PPN 111 that is the target physical address TGPPN is ‘11’, whereas the lower 2-bit value of logical address No. 6 LPN 110 is ‘10’. Accordingly, logical address No. 6 LPN 110 cannot be selected as the target logical address TGLPN.

Therefore, the controller 130 may determine whether a logical address that has not yet been received in the address buffer 21 is present among the eight logical addresses LPN<101, 001, 100, 010, 000, 110, 111, 011> for the write operation. As a result of the determination, because only seven logical addresses LPN<101, 001, 100, 010, 000, 110, 111> are stored in the address buffer 21, as shown in the drawing, the controller 130 may request reception of an additional logical address. In an embodiment, in the case where the write operation is performed in response to a request from the host 102, the controller 130 requests reception of an additional logical address from the host 102 In an embodiment, in the case where the write operation is a background operation performed in the controller 130, the controller 130 performs an operation to check for a logical address that has not been received in the address buffer 21, and stores an additional logical address in the address buffer 21.

Referring to FIG. 4C, it is in a state where, after determining the presence of the additional logical address that has not yet been received in the address buffer 21 among the eight logical addresses LPN<101, 001, 100, 010, 000, 110, 111, 011> for the write operation, as shown in FIG. 4B, and requesting the reception thereof, the additional logical address is still not received within a preset time.

In this case, the controller 130 may reselect the target physical address TGPPN by swapping a selection order between a physical address of a current turn and a physical address of a subsequent turn among the eight physical addresses PPN<000, 001, 010, 011, 100, 101, 111, 1000>, which are selected according to the preset order. Among the eight physical addresses PPN<000, 001, 010, 011, 100, 101, 111, 1000>, the selection order may be swapped between physical address No. 7 PPN 111, which is selected as the target physical address TGPPN in the current turn, and physical address No. 8 PPN 1000, which is scheduled to be selected as the target physical address TGPPN in the subsequent turn. Accordingly, physical address No. 8 PPN 1000 may be reselected as the target physical address TGPPN.

After reselecting physical address No. 8 PPN 1000 as the target physical address TGPPN, the controller 130 may determine whether logical address No. 6 LPN 110, which has not been selected as the target logical address TGLPN, among the seven logical addresses LPN<101, 001, 100, 010, 000, 110, 111>, can be set as the target logical address TGLPN. As a result of the determination, the lower 2-bit value of physical address No. 8 PPN 1000 that is the target physical address TGPPN is ‘00’, whereas the lower 2-bit value of logical address No. 6 LPN 110 is ‘10’. Accordingly, logical address No. 6 LPN 110 cannot be selected as the target logical address TGLPN.

Referring to FIG. 4D, a state is illustrated in which the operation described in FIG. 4B continues without the operation described in FIG. 4C being performed. It is in a state where, after determining the presence of the additional logical address that has not yet been received in the address buffer 21 among the eight logical addresses LPN<101, 001, 100, 010, 000, 110, 111, 011> for the write operation, as shown in FIG. 4B, and requesting the reception thereof, the additional logical address is received within the preset time. All of the eight logical addresses LPN<101, 001, 100, 010, 000, 110, 111, 011> may be stored in the address buffer 21.

The controller 130 may select physical address No. 7 PPN 111 as the target physical address TGPPN and determine whether a logical address that can be set as the target logical address TGLPN is present between logical address No. 6 LPN 110 and logical address No. 3 LPN 011, which have not been selected as the target logical address TGLPN, among the eight logical addresses LPN<101, 001, 100, 010, 000, 110, 111, 011>. As a result of the determination, the lower 2-bit value of physical address No. 7 PPN 111 that is the target physical address TGPPN is ‘11’, whereas the lower 2-bit value of logical address No. 3 LPN 011 is also ‘11’. Accordingly, logical address No. 3 LPN 011 can be selected as the target logical address TGLPN.

The controller 130 may map physical address No. 7 PPN 111 to logical address No. 3 LPN 011, and accordingly, generate seventh compressed mapping information COMMAP<6> by mapping compressed physical address MPPN 1 obtained by removing the lower 2-bits from physical address No. 7 PPN 111, to logical address No. 3 LPN 011.

Referring to FIG. 4E, it can be seen that an operation is performed after, as shown in FIG. 4D, all of the eight logical addresses LPN<101, 001, 100, 010, 000, 110, 111, 011> for the write operation are received in the address buffer 21 and the seventh compressed mapping information COMMAP<6> is generated.

After selecting physical address No. 8 PPN 1000 as the target physical address TGPPN, the controller 130 may determine whether logical address No. 6 LPN 110, which has not been selected as the target logical address TGLPN, among the eight logical addresses LPN<101, 001, 100, 010, 000, 110, 111, 011>, can be set as the target logical address TGLPN. As a result of the determination, the lower 2-bit value of physical address No. 8 PPN 1000 that is the target physical address TGPPN is ‘00’, whereas the lower 2-bit value of logical address No. 6 LPN 110 is ‘10’. Accordingly, logical address No. 6 LPN 110 cannot be selected as the target logical address TGLPN.

Therefore, the controller 130 may set physical address No. 8 PPN 1000, which has been selected as the target physical address TGPPN, as a remaining physical address RSPPN, and set logical address No. 6 LPN 110, which has not been selected as the target logical address TGLPN among the eight logical addresses LPN<101, 001, 100, 010, 000, 110, 111, 011>, as a remaining logical address RSLPN. Then, the controller 130 may map the remaining physical address RSPPN and the remaining logical address RSLPN to each other, thereby generating first remaining information RSMAP<0>. The first remaining information RSMAP<0> may be information in which logical address No. 6 LPN 110 and physical address No. 8 PPN 1000 are mapped to each other in their original form without compression.

The controller 130 may collect and manage the seven pieces of compressed mapping information COMMAP<0:6> generated through FIGS. 4A to 4D and the one piece of remaining information RSMAP<0> generated through FIG. 4E, as the compressed mapping table 23A or 23B.

In summary, the controller 130 may map each of the eight physical addresses PPN<000, 001, 010, 011, 100, 101, 111, 1000> to a corresponding one of the eight logical addresses LPN<101, 001, 100, 010, 000, 110, 111, 011> in the aforementioned manner and generate the seven pieces of compressed mapping information COMMAP<0:6> and the one piece of remaining information RSMAP<0>.

The controller 130 may arrange and manage the seven pieces of compressed mapping information COMMAP<0:6> and the one piece of remaining information RSMAP<0> as the compressed mapping table 23A or 23B. The controller 130 may generate and manage L2P information L2P and RSL2P, which defines the values of the compressed physical addresses MPPN based on the normal logical addresses NLPN, and P2L information P2L and RSP2L, which defines the values of the compressed logical addresses MLPN based on the normal physical addresses NPPN, for the seven pieces of compressed mapping information COMMAP<0:6> and the one piece of remaining information RSMAP<0>.

Referring to FIG. 4F, the controller 130 may receive the eight pieces of write data WD<0:7> corresponding to the eight normal logical addresses NLPN<000, 001, 010, 011, 100, 101, 110, 111> for the write operation, into the data buffer 22.

For example, the operation of generating the compressed mapping table 23A or 23B in the controller 130, as described with reference to FIGS. 4B to 4E, and the operation of receiving the eight pieces of write data WD<0:7> into the data buffer 22 may be performed in parallel. After the eight logical addresses LPN<101, 001, 100, 010, 000, 110, 111, 011> for the write operation are inputted to the address buffer 21, the eight pieces of write data WD<0:7> may be inputted into the data buffer 22 while the controller 130 performs the operation of generating the compressed mapping table 23A or 23B.

Specifically, with reference to the L2P information L2P and RS L2P included in the compressed mapping table 23A or 23B, i.e., the seven compressed physical addresses MPPN<1, 1, 0, 1, 0, 0, 0> and the one remaining physical address RSPPN 1000 that are mapped to the eight normal logical addresses NLPN<000, 001, 010, 011, 100, 101, 110, 111>, the controller 130 may determine the eight normal physical addresses NPPN<100, 101, 010, 111, 000, 001, 011, 1000> corresponding to the eight normal logical addresses NLPN<000, 001, 010, 011, 100, 101, 110, 111>.

For the seven normal logical addresses NLPN<000, 001, 010, 011, 100, 101, 111>, which are mapped to the seven compressed physical addresses MPPN<1, 1, 0, 1, 0, 0, 0>, among the eight normal logical addresses NLPN<000, 001, 010, 011, 100, 101, 110, 111>, the controller 130 may determine the seven normal physical addresses NPPN<100, 101, 010, 111, 000, 001, 011> respectively corresponding to the seven logical addresses NLPN<000, 001, 010, 011, 100, 101, 111> by appending the lower 2-bit value of each of the seven normal logical addresses NLPN<000, 001, 010, 011, 100, 101, 111> to the lower 2 bits of a corresponding one of the seven compressed physical addresses MPPN<1, 1, 0, 1, 0, 0, 0>. For the one normal logical address NLPN 110, which is mapped to the one remaining physical address RSPPN 1000, among the eight normal logical addresses NLPN<000, 001, 010, 011, 100, 101, 110, 111>, the controller 130 may set the remaining physical address RSPPN 1000 as the one normal physical address NPPN 1000 without modification.

Therefore, the controller 130 may determine eight storage spaces PB<4, 5, 2, 7, 0, 1, 8, 3> that respectively correspond to the eight normal logical addresses NLPN<000, 001, 010, 011, 100, 101, 110, 111>.

Therefore, the controller 130 may store each of the eight pieces of write data WD<0:7> in a corresponding one of the eight storage spaces PB<4, 5, 2, 7, 0, 1, 8, 3>, which respectively correspond to the eight normal logical addresses NLPN<000, 001, 010, 011, 100, 101, 110, 111>.

For the seven normal logical addresses NLPN<000, 001, 010, 011, 100, 101, 111>, to which the seven compressed physical addresses MPPN<1, 1, 0, 1, 0, 0, 0> are mapped, among the eight normal logical addresses NLPN<000, 001, 010, 011, 100, 101, 110, 111>, the controller 130 may store each of the seven pieces of write data WD<0:5, 7> in a corresponding one of the respective data sectors DSEC of the seventh storage spaces PB<4, 5, 2, 7, 0, 1, 3>, which respectively correspond to the seven normal logical addresses NLPN<000, 001, 010, 011, 100, 101, 111>, and may store each of seven compressed logical addressees MLPN<0, 0, 0, 0, 1, 1, 1, 1> in a corresponding one of the spare sectors SSEC.

For the one normal logical address NLPN 110, to which the one remaining physical address RSPPN 1000 is mapped, among the eight normal logical addresses NLPN<000, 001, 010, 011, 100, 101, 110, 111>, the controller 130 may store the one write data WD6 in the data sector DSEC of the one storage space PB 8 corresponding to the one normal logical address NLPN 110, and may store the one normal logical address NLPN 110 in a corresponding spare sector SSEC.

Referring to FIG. 4G, an operation is illustrated for the case where a read logical address READ LPN is received in a state where K pieces of write data WD<0:7> are stored in K storage spaces among the plurality of storage spaces PB<0:7, . . . > included in the first memory device 150 through the operations described with reference to FIGS. 4A to 4F.

Upon input of the read logical address READ LPN into the address buffer 21, the controller 130 may search for a compressed physical address MPPN or a remaining physical address RSPPN that corresponds to the read logical address READ LPN, with reference to the compressed mapping table 23A or 23B.

In the case where the compressed physical address MPPN corresponding to the read logical address READ LPN is searched for from the compressed mapping table 23A or 23B, the controller 130 may determine, as the read logical address, the value of the normal physical address NPPN that is obtained by appending an N-bit value at a designated location of the read logical address READ LPN to the designated location of the searched compressed physical address MPPN.

In the case where the remaining logical address RSLPN corresponding to the read logical address READ LPN is searched for from the compressed mapping table 23A or 23B, the controller 130 may determine the searched remaining logical address RSLPN as the read logical address without modification.

The controller 130 may read data stored in a specific storage space corresponding to the read logical address among the plurality of storage spaces included in the first memory device 150.

In an embodiment, a read logical address READ LPN having the value ‘110’ is inputted to the address buffer 21 in a state where the eight pieces of write data WD<0:7> are stored in the eight storage spaces among the plurality of storage spaces PB<0:7, . . . > included in the first memory device 150 through the operations described with reference to FIGS. 4A to 4F, however, other values may be used.

The controller 130 may determine that the remaining physical address RSPPN is mapped to the normal logical address NLPN 110, which has a read logical address value of ‘110’, among the eight normal logical addresses NLPN<000, 001, 010, 011, 100, 101, 110, 111> included in the compressed mapping table 23A or 23B, and may determine the normal physical address NPPN as the value ‘1000’ of the remaining physical address RSPPN without modification. Therefore, the controller 130 may read the data WD6 stored in storage space No. 8 PB8, which corresponds to the normal physical address NPPN having the value ‘1000’.

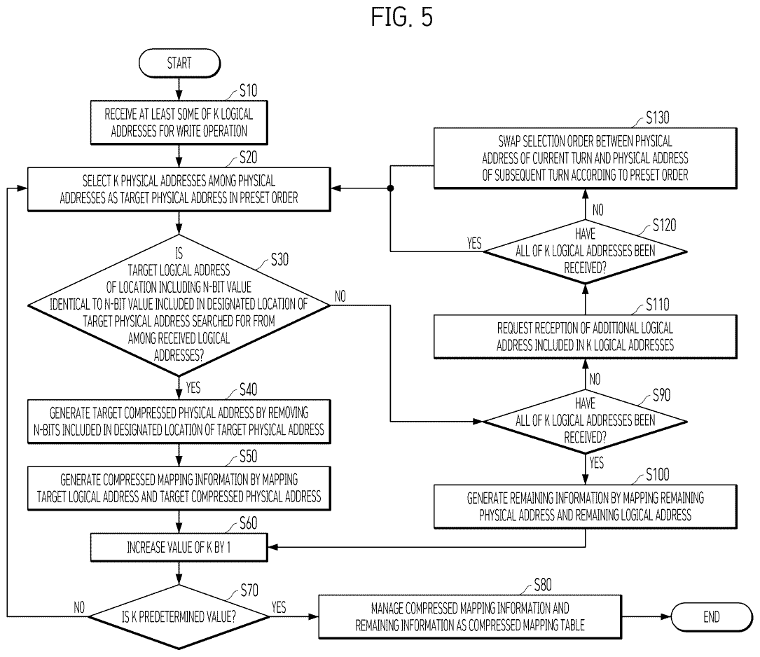

FIG. 5 is a flowchart illustrating a sequence of an operation of compressing and storing mapping information in the storage device according to an embodiment of the present disclosure.

Referring to FIG. 5, at least some of K logical addresses for a write operation are received, in operation S10.

K physical addresses are sequentially selected one by one as target physical addresses TGPPN in a preset order from among the plurality of physical addresses respectively corresponding to the plurality of storage spaces included in the memory device 150, in operation S20.

In operation S30, it is determined whether a target logical address TGLPN of a location including an N-bit value, obtained by applying a preset conversion rule to an N-bit value included in the designated location of the target physical address TGPPN selected in S20, is searched for among the logical addresses received in operation S10.

In the case where the target logical address TGLPN corresponding to the target physical address TGPPN is searched for in operation S30 (see YES in S30), a target compressed physical address may be generated in operation S40 by removing the N-bit value at the designated location of the target physical address TGPPN.

In operation S50, compressed mapping information COMMAP is generated by mapping the target compressed physical address generated in operation S40 to the target logical address TGLPN searched for in operation S30.

If the compressed mapping information COMMAP is generated in operation S50, the value of K is increased by 1, in operation S60.

In operation S70, it is determined whether the value of K increased by 1 in operation S60 is a predetermined value.

In the case the value of K is not the predetermined value in operation S70 (see NO in S70), the process returns to operation S20. Because the target logical address TGLPN corresponding to the currently selected target physical address TGPPN has been searched for through the operations S30 to S50, a new target physical address TGPPN is set in operation S20 according to the preset order, and subsequent operations S30, S40, S50, and S60 or S30, S90, S100, S110, S120, and S130 are performed.

In the case where the target logical address TGLPN corresponding to the target physical address TGPPN is not searched for in operation S30 (see NO in S30), it is determined whether all of the K logical addresses have been received in operation S90.

In the case where not all of the K logical addresses have been received in operation S90 (see NO in S90), a request is made in operation S110 to receive an additional logical address included in the K logical addresses scheduled to be received for the write operation.

In operation S120, it is determined whether the additional logical address is received within a preset time after requesting the reception of the additional logical address in operation S110.

In the case where the additional logical address is received within the preset time in operation S120 (see YES in S120), the process returns to operation S20. Because the target logical address TGLPN corresponding to the currently selected target physical address TGPPN has not been searched for through the operations S30, S90, S110, and S120, the currently selected target physical address TGPPN is maintained in operation S20, and subsequent operations S30, S40, S50, and S60 or S30, S90, S100, S110, S120, and S130 are performed.

In the case where the additional logical address is not received within the preset time in operation S120 (see NO in S120), the selection order between the physical address of the current turn and the physical address of the subsequent turn according to the preset order may be swapped in operation S130. That is, before reaching operation S130, the physical address of the current turn, according to the preset order, may be set as the target physical address TGPPN. In operation S130, by swapping the physical address of the current turn with the physical address of the subsequent turn according to the preset order, the physical address of the subsequent turn may be reselected as the target physical address TGPPN in the subsequent operation S20. After operation S130, the process moves to operation S20, where the reselected target physical address TGPPN is used to perform the subsequent operations S30, S40, S50, and S60, or S30, S90, S100, S110, S120, and S130.

In the case where all of the K logical addresses are received in operation S90 (see YES of S90), a logical address that has not been selected as the target logical address TGLPN among the received logical addresses is set as a remaining logical address. In addition, among the K physical addresses according to the preset order, a physical address that has been selected as the target physical address TGPPN but has not been mapped to the target logical address TGLPN is set as a remaining physical address. Remaining information is generated by mapping the remaining logical address and the remaining physical address in operation S100.

After operation S100, the value of K is increased by 1 in operation S60.

In operation S70, it is determined whether the value of K increased by 1 in operation S60 is a predetermined value.

In the case where the value of K is the predetermined value in operation S70 (see YES in S70), the compressed mapping information COMMAP and the remaining information RSMAP may be managed as the compressed mapping table 23A or 23B. The compressed mapping table 23A or 23B may include only the K pieces of compressed mapping information COMMAP, as shown in FIGS. 3A to 3F. Furthermore, the compressed mapping table 23A or 23B may include a combination of the compressed mapping information COMMAP and the remaining information RSMAP, as shown in FIGS. 4A to 4F.

In an embodiment, during a process of mapping a logical address for a write operation to a physical address, mapping information may be generated with some bits, having values obtained by applying a conversion rule set between the logical address and the physical address, being deleted.

Accordingly, the number of bits required for the mapping information between the logical address and the physical address may be minimized.

It will be evident to a person having ordinary knowledge in the art to which the present disclosure pertains that the embodiments of the present disclosure described above are not limited by the aforementioned embodiments and the accompanying drawings and that the embodiments may be substituted, modified, and changed in various ways without departing from the technical scope of the present disclosure. Furthermore, the embodiments may be combined to form additional embodiments.

What is claimed is:

1. A method of operating a storage device including a memory device with a plurality of storage spaces respectively corresponding to a plurality of physical addresses, the method comprising:
a receiving operation of receiving at least one of K logical addresses for a write operation, where K is a natural number;
a determination operation of determining an N-bit value included in a location corresponding to a target physical address among the plurality of physical addresses, where N is a natural number;
a logical selection operation of searching for and selecting, from among the at least one of K logical addresses received in the receiving operation, a target logical address of a location including an N-bit value, obtained by applying a preset conversion rule to the N-bit value determined in the determination operation; and
a first generation operation of generating, in response to the target logical address searched for in the logical selection operation, compressed mapping information by mapping, to the target logical address, a target compressed physical address generated by removing, from the target physical address, the N-bit value in the location corresponding to the target physical address.

2. The method of claim 1, further comprising:
an operation of receiving target write data corresponding to the target logical address; and
an operation of storing the target write data in a data sector of a target storage space corresponding to the target physical address, and storing a compressed logical address, in a spare sector of the target storage space, the compressed logical address being obtained by removing, from the target logical address, the N-bit value in the location corresponding to the target logical address.

3. The method of claim 2, further comprising:
a physical selection operation of selecting K physical addresses one by one as the target physical address in a preset order from among the plurality of physical addresses;
a performing operation of performing each of the determination operation, the logical selection operation, and the first generation operation for the target physical address selected in the physical selection operation; and
an operation of managing up to K pieces of the compressed mapping information, which are generated by performing the physical selection operation and the performing operation K times, as a compressed mapping table.

4. The method of claim 3, further comprising:
an operation of requesting reception of an additional logical address included in the K logical addresses in response to the target logical address that is not selected in the logical selection operation while not all of the K logical addresses are received in the receiving operation; and
an operation of performing the logical selection operation again in response to the reception of the additional logical address.

5. The method of claim 4, further comprising an operation of reselecting, in response to the additional logical address that is not received within a preset time after performing the operation of requesting the reception, the target physical address by swapping a selection order between a physical address of a current turn and a physical address of a subsequent turn according to the preset order in the physical selection operation, and performing the performing operation for the reselected target physical address.

6. The method of claim 3, further comprising:
a second generation operation of generating, in response to the target logical address that is not selected in the logical selection operation while all of the K logical addresses are received in the receiving operation, remaining information by mapping, to a remaining logical address which is not selected in the logical selection operation, a remaining physical address which is selected as the target physical address in the physical selection operation and for which the corresponding target logical address is not searched in the logical selection operation; and
an operation of managing the compressed mapping table with the remaining information included.

7. The method of claim 6, further comprising:
an operation of receiving a read logical address;
a searching operation of searching for the compressed physical address or the remaining physical address, which corresponds to the read logical address, with reference to the compressed mapping table;
an operation of determining, in response to the compressed physical address searched for in the searching operation, a read physical address by appending an N-bit value in the location corresponding to the read logical address to the location corresponding to the compressed physical address searched for in the searching operation;
an operation of setting, in response to the remaining physical address searched for in the searching operation, the searched remaining physical address as the read physical address; and
an operation of reading data from a storage space corresponding to the read physical address, among the plurality of storage spaces.

8. The method of claim 6,
wherein the memory device comprises a non-volatile memory device,
wherein the storage device further comprises a volatile memory device, the method further comprising:
an operation of managing the compressed mapping table in the volatile memory device; and
an operation of backing up the compressed mapping table to the non-volatile memory device.

9. The method of claim 6,
wherein the memory device comprises a nonvolatile memory device,
wherein the storage device further comprises a volatile memory device, the method further comprising:
an operation of backing up the compressed mapping table to the nonvolatile memory device;
a conversion operation of converting at least a portion of information in the compressed mapping table into normal mapping information; and
an operation of managing the normal mapping information converted in the conversion operation in the volatile memory device as a normal mapping table, and
wherein the conversion operation comprises:
an operation of converting, in response to the at least portion of the information being the compressed mapping information, the at least portion of the information into the normal mapping information by appending an N-bit value in a location corresponding to a logical address included in the at least portion of the information to a location corresponding to a physical address through mapping; and
an operation of converting the remaining information into the normal mapping information without modification, in response to the at least portion of the information being the remaining information.

10. The method of claim 6, further comprising:
an operation of dividing the plurality of storage spaces included in the memory device into a first storage area and a second storage area;
an operation of storing the target write data and the compressed logical address in the first storage area; and
an operation of managing the compressed mapping table in the second storage area.

11. A storage device comprising:
a memory device including a plurality of storage spaces respectively corresponding to a plurality of physical addresses; and
a controller configured to
receive at least one of K logical addresses for a write operation,
store the at least one of K logical addresses in an internal address buffer,
search for and select, from among the at least one of K logical addresses stored in the address buffer, a target logical address of a location including an N-bit value, obtained by applying a preset conversion rule to an N-bit value included in the location corresponding to a target physical address of the plurality of physical addresses, and
generate, when the target logical address is searched for, compressed mapping information by mapping, to the target logical address, a target compressed physical address generated by removing, from the target physical address, the N-bit value in the location corresponding to the target physical address,
wherein each of K and N is a natural number.

12. The storage device of claim 11, wherein the controller is configured to:
receive target write data corresponding to the target logical address;
store the target write data in an internal data buffer;
store the target write data in a data sector of a target storage space corresponding to the target physical address; and
store a compressed logical address in a spare sector of the target storage space, the compressed logical address being obtained by removing, from the target logical address, the N-bit value in the location corresponding to the target logical address.

13. The storage device of claim 12, wherein the controller is configured to:
perform a selection operation of selecting K physical addresses one by one as the target physical address in a preset order from among the plurality of physical addresses;
perform a first searching operation of searching for and selecting, among the at least one of K logical addresses stored in the address buffer, a target logical address of a location including an N-bit value, obtained by applying a preset conversion rule to an N-bit value included in the location corresponding to the target physical address selected in the selection operation;
perform a generation operation of generating, when the target logical address is selected in the first searching operation, compressed mapping information by mapping, to the target logical address selected in the first searching operation, a target compressed physical address generated by removing an N-bit value included in a location corresponding to the target physical address selected in the selection operation; and
manage up to K pieces of the compressed mapping information, which are generated by performing the selection operation, the first searching operation, and the generation operation K times, as a compressed mapping table.

14. The storage device of claim 13, wherein, when the target logical address is not selected in the first searching operation and not all of the K logical addresses are received in the address buffer, the controller is configured to:
request reception of an additional logical address included in the K logical addresses;
store the additional logical address in the address buffer upon the reception of the additional logical address; and
perform the first searching operation and the generation operation.

15. The storage device of claim 14, wherein, when the additional logical address is not received within a preset time after requesting the reception of the additional logical address, the controller is configured to:
reselect the target physical address by swapping a selection order between a physical address of a current turn and a physical address of a subsequent turn, among the K physical addresses selected according to the preset order; and
perform the first searching operation and the generation operation for the reselected target physical address.

16. The storage device of claim 13, wherein, when the target logical address is not selected in the first searching operation and all of the K logical addresses are received in the address buffer, the controller is configured to:
generate remaining information by mapping, to a remaining logical address, which is not selected in the first searching operation, a remaining physical address, which is selected as the target physical address in the selection operation and for which the corresponding target logical address is not searched in the first searching operation; and
manage the compressed mapping table with the remaining information included.

17. The storage device of claim 16, wherein the controller is configured to:
perform a second searching operation of searching for the compressed physical address or the remaining physical address, which corresponds to the read logical address, with reference to the compressed mapping table;
perform an operation of determining, when the compressed physical address is searched for in the second searching operation, a read physical address by appending an N-bit value in the location corresponding to the read logical address to the location corresponding to the compressed physical address searched for in the second searching operation;
an operation of setting, when the remaining physical address is searched for in the second searching operation, the searched remaining physical address as the read physical address; and
an operation of reading data from a storage space corresponding to the read physical address, among the plurality of storage spaces.

18. The storage device of claim 16,
wherein the memory device comprises a non-volatile memory device,
wherein the controller comprises a volatile memory device, and
wherein the controller is configured to manage the compressed mapping table in the volatile memory device, and backs up the compressed mapping table to the non-volatile memory device.

19. The storage device of claim 16,
wherein the memory device comprises a nonvolatile memory device,
wherein the controller comprises a volatile memory device, and
wherein the controller is configured to:
back up the compressed mapping table to the nonvolatile memory device;
select at least a portion of information from the compressed mapping table,
convert the at least portion of the information into normal mapping information;
manage the converted normal mapping information as a normal mapping table in the volatile memory device;
convert, when the at least portion of the information is the compressed mapping information, the at least portion of the information into the normal mapping information by appending an N-bit value in a location corresponding to a logical address included in the at least portion of the information to a location corresponding to a physical address through mapping; and
convert the remaining information into the normal mapping information without modification when the at least portion of the information is the remaining information.

20. The storage device of claim 16, wherein the controller is configured to:
divide the plurality of storage spaces included in the memory device into a first storage area and a second storage area;
store the target write data and the compressed logical address in the first storage area; and
manage the compressed mapping table in the second storage area.
